(19) United States
(12) Patent Application Publication
(10) Pub. No.: US 2008/0155082 A1
(43) Pub. Date: Jun. 26, 2008

(54) Computer-readable medium storing file delivery program, file delivery apparatus, and distributed file system

(75) Inventors: Takeshi Ohtani, Kawasaki (JP); Makoto Kubota, Kawasaki (JP); Toshihiko Kurita, Kawasaki (JP); Toshihiko Naritomi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/907,129

(22) Filed: Oct. 9, 2007

(30) Foreign Application Priority Data
Dec. 22, 2006 (JP) 2006-345237

(51) Int. Cl. G06F 15/16

(52) U.S. Cl. 709/223

(57) ABSTRACT

In a distributed file system, a file server stores files, and a cache server stores copies of files, server information, and control information. The server information defines a communication procedure used in communication with the file server, and the control information controls a client so that in case of necessity of a file, the client sends a file-acquisition request to the cache server when the cache server is in operation, and to the file server in accordance with the server information when the cache server is not in operation. The cache server sends to the client the control information and the server information in response to a startup notice sent from the client, and sends, in response to a file-acquisition request sent from the client, one of the copies of the files corresponding to the file-acquisition request received, to the client.

### CROSS-REFERENCE TO RELATED APPLICATIONS

This application is based upon and claims the benefits of priority from the prior Japanese Patent Application No. 2006-345237 filed on Dec. 22, 2006, the entire contents of which are incorporated herein by reference.

### BACKGROUND OF THE INVENTION

1. Field of the Invention

The present invention relates to a file delivery apparatus, a distributed file system, and a computer-readable medium storing a file delivery program for storing and delivering copies of files.

2. Description of the Related Art

The recent development of the network technology has lead to the current widespread use of the network-type file systems. In the network-type file systems, file servers manage files, and clients acquire files from the file servers through a network when necessary. When the files are deployed in file servers, the files can be easily managed and shared. (See, for example, Japanese Unexamined Patent Publication No. 2005-538432.)

In particular, in some cases, most of files including the files of OS (Operation System) programs are deployed in file servers and not in clients. In such cases, each client acquires an OS program from a file server, and performs startup processing, on startup of the client. Thereafter, the client acquires additional files from the file server when necessary. The clients which behave as above are called thin clients. Since the thin clients do not store files in an auxiliary storage device such as a hard disk drive (HDD), use of the thin clients contributes to reduction of the risk of information leakage.

In many large-scale organizations, geographically remote computers are connected through a wide-area network, and each thin client may be remotely located from the file server. Since the delay in communication through a wide-area network is greater than the delay in communication within a local-area network, much time is needed for a thin client connected with a file server through a wide-area network to acquire a file. In a known technique proposed for solving this problem, a cache server provided in a local-area network acquires a copy of a file from a file server and holds the acquired copy. (See, for example, Japanese Unexamined Patent Publications Nos. 2002-123400 and 2005-339097, which are hereinafter referred to as JPP 2002-123400 and JPP 2005-339097, respectively.) According to this technique, each thin client can acquire a file by simply performing communication with a cache server arranged in a local-area network to which the thin client belongs, so that it is possible to reduce the time necessary for acquiring a file.

Incidentally, in the systems containing thin clients, it is necessary to increase the availability of the file server. When the thin clients start up, the thin clients have almost no files necessary for processing. Therefore, when a trouble occurs in the file server, the thin clients cannot perform processing. In a known technique proposed for solving this problem, the availability of the file server is increased by multiply arranging file servers. (See, for example, Japanese Unexamined Patent Publication No. 2001-344141, which is hereinafter referred to as JPP 2001-344141.) Each thin client acquires files from a main server when the main server is in normal operation, and from an alternative server when a trouble occurs in the main server. Therefore, it is possible to reduce the risk that each thin client cannot perform processing.

It may be considered that a system containing thin clients and having high availability can be realized by combining the techniques proposed in JPP 2002-123400, JPP 2005-339097, and JPP 2001-344141. That is, it may be considered that the time necessary for acquiring a file can be reduced by arranging a cache server in a local-area network, and the availability of the system can be increased by multiply arranging cache servers in the local-area network. However, it is not realistic to provide a plurality of cache servers in each local-area network since the provision of a plurality of cache servers in each local-area network greatly increases the implementation cost and the maintenance cost.

Therefore, there is a demand to use a cache server as a main server and a file server as an alternative server, i.e., there is a demand that each thin client establish a connection with a cache server in a local-area network to which the thin client belongs when the cache server is in normal operation, and establish a connection with a file server through a wide-area network when the cache server is not in normal operation. Nevertheless, such a demand cannot be satisfied by the techniques disclosed in JPP 2002-123400, JPP 2005-339097, and JPP 2001-344141 for the following reasons.

Normally, communication within a local-area network and communication through a wide-area network use different communication protocols. For example, the communication within a local-area network uses a simple communication protocol which is designed on the premise that the frequency of communication errors is small, and the communication through a wide-area network uses a secure communication protocol which is designed on the premise that the frequency of communication errors is great. There are various types of communication protocols which can be used in communication through a wide-area network.

Therefore, thin client has to appropriately switch a communication method according to a server to be connected. However, it is hard for the thin client to perform such switching.

### SUMMARY OF THE INVENTION

The first object of the present invention is to provide a file delivery apparatus and a distributed file system which enables a client to establish a connection with a cache server when the cache server is in normal operation, and with a file server through a wide-area network when the cache server is not in normal operation.

The second object of the present invention is to provide a computer-readable medium storing a file delivery program which enables a client to establish a connection with a cache server when the cache server is in normal operation, and with a file server through a wide-area network when the cache server is not in normal operation.

In order to accomplish the first object, according to the first aspect of the present invention, a computer-readable medium storing a file delivery program which makes a computer realize an apparatus for storing and delivering copies of files is provided. The file delivery apparatus comprises: a file storing unit which stores the copies of the files, where originals of the files are stored in one or more file servers connected to the computer through a network; a server-information storing unit which stores server information defining one or more communication procedures in accordance with which communication with the one or more file servers is to be performed through the network; a control-information storing unit which stores control information for controlling a client so that in case of necessity of a file, the client sends a file-acquisition request to the computer when the computer is in operation, and to the one or more file servers in accordance with the server information when the computer is not in operation; a startup-information sending unit which sends to the client the control information stored in the control-information storing unit and the server information stored in the server-information storing unit, in response to a startup notice, which is sent from the client when the client starts up; and a file sending unit which sends, in response to a file-acquisition request received by the computer, one of the copies of the files stored in the file storing unit corresponding to the file-acquisition request received by the computer, to the client.

In addition, in order to accomplish the first object, according to the second aspect of the present invention, a file delivery apparatus for storing and delivering copies of files is also provided. The file delivery apparatus comprises: a file storing unit which stores the copies of the files, where originals of the files are stored in one or more file servers connected to the file delivery apparatus through a network; a server-information storing unit which stores server information defining one or more communication procedures in accordance with which communication with the one or more file servers is to be performed through the network; a control-information storing unit which stores control information for controlling a client so that in case of necessity of a file, the client sends a file-acquisition request to the file delivery apparatus when the file delivery apparatus is in operation, and to the one or more file servers in accordance with the server information when the file delivery apparatus is not in operation; a startup-information sending unit which sends to the client the control information stored in the control-information storing unit and the server information stored in the server-information storing unit, in response to a startup notice, which is sent from the client when the client starts up; and a file sending unit which sends, in response to a file-acquisition request received by the file delivery apparatus, one of the copies of the files stored in the file storing unit corresponding to the file-acquisition request received by the file delivery apparatus, to the client.

Further, in order to accomplish the second object, according to the third aspect of the present invention, a distributed file system in which copies of files are stored and delivered is provided. The distributed file system comprises: a file server, a cache server, and a client. The file server includes, a first file storing unit which stores the files, and a first file sending unit which sends, in response to a file-acquisition request received by the file server through a network, one of the files stored in the first file storing unit corresponding to the file-acquisition request received by the file server, to a device from which the file-acquisition request is received by the file server. The cache server includes, a second file storing unit which stores the copies of the files, a second file sending unit which sends, in response to a file-acquisition request received by the cache server, one of the copies of the files stored in the second file storing unit corresponding to the file-acquisition request received by the cache server, to a device from which the file-acquisition request is received by the cache server, a server-information storing unit which stores server information defining a communication procedure in accordance with which communication with the file server is to be performed through the network, a control-information storing unit which stores control information for controlling a computer so that in case of necessity of a file, the computer acquires a copy of the file from the second file sending unit when the second file sending unit is in operation, and acquires the file from the file server in accordance with the server information when the second file sending unit is not in operation, and a startup-information sending unit which sends, in response to a startup notice received by the cache server, the control information stored in the control-information storing unit and the server information stored in the server-information storing unit, to a device from which the startup notice is received. The client includes, a startup unit which sends a startup notice to the cache server, and acquires the control information and the server information, when the client starts up, and a file acquisition unit which, when the client needs a file, checks an operational status of the cache server, and acquires the file needed by the client, by sending a file-acquisition request to one of the cache server and the file server on the basis of the control information and the server information acquired by the startup unit.

The above and other objects, features and advantages of the present invention will become apparent from the following description when taken in conjunction with the accompanying drawings which illustrate preferred embodiment of the present invention by way of example.

### BRIEF DESCRIPTION OF THE DRAWINGS

FIG. 1 is a diagram illustrating an outline of embodiments of the present invention.

FIG. 2 is a diagram illustrating an example of a configuration of a distributed file system according to the first embodiment of the present invention.

FIG. 3 is a diagram illustrating a hardware construction of a relay server used in the first embodiment.

FIG. 4 is a diagram illustrating a hardware construction of one of clients used in the first embodiment.

FIG. 5 is a block diagram illustrating the functions of a management server and the relay server according to the first embodiment.

FIG. 6 is a block diagram illustrating the functions of one of the clients according to the first embodiment.

FIG. 7 is a diagram illustrating an example of a data structure of a server-information table according to the first embodiment.

FIG. 8 is a flow diagram indicating a sequence of startup processing according to the first embodiment.

FIG. 9 is a flow diagram indicating a sequence of file-operation processing according to the first embodiment.

FIG. 10 is a diagram illustrating an example of a configuration of a distributed file system according to the second embodiment.

FIG. 11 is a block diagram illustrating the functions of a relay server and part of management servers according to the second embodiment.

FIG. 12 is a diagram illustrating an example of a data structure of a server-information table according to the second embodiment.

FIG. 13 is a flow diagram indicating a sequence of file-operation processing according to the second embodiment.

FIG. 14 is a block diagram illustrating the functions of a relay server and part of management servers according to the third embodiment of the present invention.

FIG. 15 is a block diagram illustrating the functions of one of clients according to the third embodiment.

FIG. 16 is a diagram illustrating an example of a data structure of a client-information table according to the third embodiment.

FIG. 17 is a flow diagram indicating a sequence of server-change processing according to the third embodiment.

FIG. 18 is a block diagram illustrating the functions of a relay server and part of management servers according to the fourth embodiment of the present invention.

FIG. 19 is a block diagram illustrating the functions of one of clients according to the fourth embodiment.

FIG. 20 is a flow diagram indicating a sequence of startup processing according to the fourth embodiment.

FIG. 21 is a diagram illustrating an example of a data structure of a registration request according to the fourth embodiment.

FIG. 22 is a flow diagram indicating a sequence of server-change processing according to the fourth embodiment.

FIG. 23 is a diagram illustrating an example of a data structure of a change notice according to the fourth embodiment.

FIG. 24 is a flow diagram indicating a sequence of server-change processing according to the fifth embodiment of the present invention.

### DESCRIPTION OF THE PREFERRED EMBODIMENTS

Preferred embodiments of the present invention will be described below with reference to the accompanying drawings, wherein like reference numbers refer to like elements throughout. First, an outline of the present invention which is realized in the embodiments is indicated, and thereafter details of the embodiments are explained.

### 1. Outline of the Present Invention

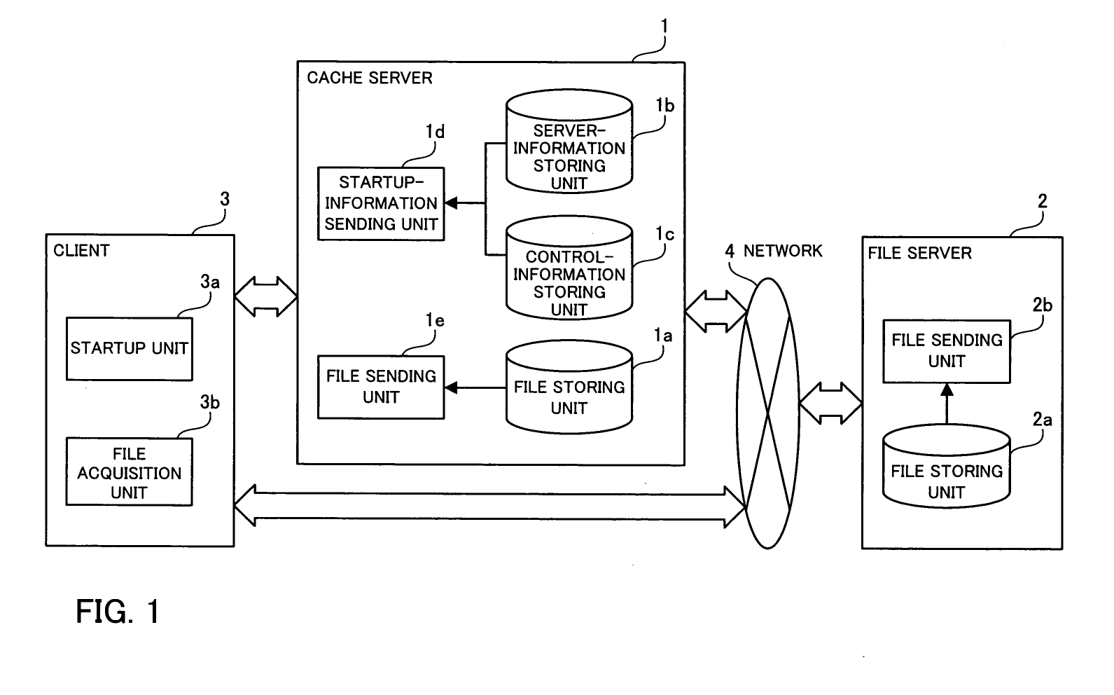

FIG. 1 is a diagram illustrating an outline of embodiments of the present invention. In the distributed file system of FIG. 1, the cache server 1 stores copies of files managed by the file server 2, and delivers the copies to the client 3. Each of the cache server 1, the file server 2, and the client 3 is realized by a computer. Each of the cache server 1 and the client 3 is connected to the file server 2 through the network 4.

The cache server 1 comprises a file storing unit 1a, a server-information storing unit 1b, a control-information storing unit 1c, a startup-information sending unit 1d, and a file sending unit 1e.

The file storing unit 1a stores copies of only the files which are held by the file server 2 and can be used by the client 3. The files the copies of which are stored in the file storing unit 1a are, for example, program files, setting files which define the initial states of the programs, data files, and the like. For example, the copies of the files are acquired in advance from the file server 2 through the network 4.

The server-information storing unit 1b stores server information on the file server 2. The server information defines a communication procedure in accordance with which communication is to be performed for acquiring a file from the file server 2 through the network 4. For example, the server information contains the address of the file server 2, a communication protocol and a port number which are used for acquiring the file, and the like.

The control-information storing unit 1c stores control information. The control information is information for controlling the computer in accordance with a predetermined procedure in the case where an unacquired file becomes necessary. In the predetermined procedure, the file is acquired from the cache server 1 when the cache server 1 is in operation, and from the file server 2 when the cache server 1 is not in operation. For example, the control information is a program or a program module which defines the above predetermined procedure.

The startup-information sending unit 1d sends the control information (stored in the control-information storing unit 1c) and the server information (stored in the server-information storing unit 1b) to the client 3 in response to a startup notice, which is sent from the client 3.

On receipt of a file-acquisition request sent from the client 3, the file sending unit 1e extracts from the file storing unit 1a a file corresponding to the file-acquisition request, and sends the extracted file to the client 3. However, when the file storing unit 1a does not contain the file corresponding to the file-acquisition request, the file sending unit 1e acquires the file from the file server 2 through the network 4, and stores the acquired file in the file storing unit 1a. At this time, the file sending unit 1e refers to the server information stored in the server-information storing unit 1b.

The file server 2 comprises a file storing unit 2a and a file sending unit 2b. The file storing unit 2a stores the originals of the files. The file storing unit 2a stores the same types of files as the types of the files stored in the file storing unit 1a. On receipt of a file-acquisition request sent from the cache server 1 or the client 3, the file sending unit 2b extracts from the file storing unit 2a a file corresponding to the file-acquisition request, and sends the extracted file to the source of the file-acquisition request.

The client 3 comprises a startup unit 3a and a file acquisition unit 3b. When the startup unit 3a detects startup of the client 3, the startup unit 3a sends a startup notice to the cache server 1. Then, the startup unit 3a receives control information and server information, which are sent from the cache server 1 in response to the startup notice, and makes the received control information and server information usable. For example, in the case where the control information is a program, the startup unit 3a loads the program in a memory so as to perform a procedure indicated in control information at the time of acquiring a file.

When a file which has not yet been acquired becomes necessary after startup of the client 3, the file acquisition unit 3b acquires the file from the cache server 1 or the file server 2 in accordance with the procedure indicated in the control information. Specifically, in the case where the cache server 1 is in operation, the file acquisition unit 3b sends a file-acquisition request to the cache server 1. On the other hand, in the case where the cache server 1 is not in operation, the file acquisition unit 3b sends a file-acquisition request to the file server 2. In the latter case, the file acquisition unit 3b performs communication with the file server 2 through the network 4 in accordance with the communication procedure indicated by the server information.

In the distributed file system having the above construction, the file server 2 stores the originals of the files, and the cache server 1 stores the copies of the files stored in the file server 2. In addition, the cache server 1 stores the server information and the control information, where the server information defines the communication procedure for the communication with the file server 2, and the control information controls the operations of the client 3 so as to send a file-acquisition request to the cache server 1 when the cache server 1 is in operation, and to the file server 2 when the cache server 1 is not in operation. Thus, the client 3 acquires a file by sending a file-acquisition request to the cache server 1 when the cache server 1 is in operation, and to the file server 2 when the cache server 1 is not in operation. In other words, the client 3 can be normally connected with the cache server 1, and with the file server 2 in accordance with the communication procedure requested by the file server 2 when the cache server 1 fails. Therefore, it is possible to realize a distributed file system which exhibits both of high response performance and high availability irrespectively of the types of the file server 2 and the network 4.

In particular, according to the present invention, information which defines processing for properly using the cache server 1 and the file server 2 is not required to be installed in the client 3 in advance. Therefore, thin clients (which do not have an auxiliary storage device) can be used as the client 3. In the embodiments of the present invention which are explained below, it is assumed that all the clients are thin clients without no auxiliary storage device.

### 2. First Embodiment

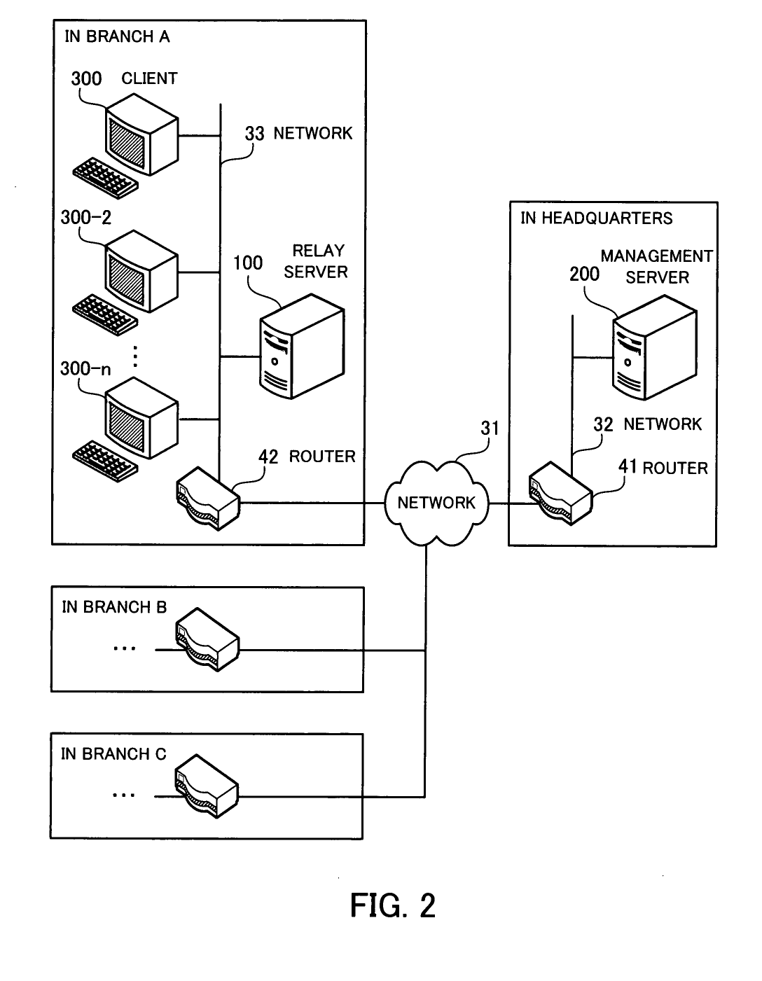

Hereinbelow, details of the preferred embodiments of the present invention are explained with reference to FIGS. 2 to 24. First, the first embodiment of the present invention is explained with reference to FIGS. 2 to 9.

### 2.1 System Configuration

FIG. 2 is a diagram illustrating an example of a configuration of a distributed file system according to the first embodiment. The distributed file system according to the first embodiment enables clients (located on the premises of branches of a company) to use files managed by a server located on the premises of the headquarters of the company. In the distributed file system according to the first embodiment, the files to be used by the clients are collectively managed by the server. Therefore, the collective management of the files by the server facilitates the management of the files and contributes to prevention of unauthorized use of the files.

As illustrated in FIG. 2, a network 32, a router 41, and a management server 200 are arranged on the premises of the headquarters of the company. The network 32 is a local-area network in the headquarters of the company, and the management server 200 is connected with the network 32. The router 41 connects the network 32 with a network 31, which is a wide-area network.

Further, a network 33, a router 42, a relay server 100, and clients 300, 300-2, . . . 300-n are arranged on the premises of the branch A. The network 33 is a local-area network in the branch A, and the relay server 100 and the clients 300, 300-2, . . . 300-n are connected with the network 33. The router 42 connects the network 33 with the network 31. Furthermore, a similar construction to the branch A is provided in each of the branches B and C.

The management server 200 is a file server which stores the originals of the files which are to be used by the clients 300, 300-2, . . . 300-n, and the relay server 100 is a cache server corresponding to the management server 200. That is, the relay server 100 holds copies of files which have been requested until then by the clients 300, 300-2, . . . 300-n. When the relay server 100 does not hold the copies of files, the relay server 100 acquires the copies of files from the management server 200 as appropriate. The clients 300, 300-2, . . . 300-n acquire the copies of files from the relay server 100 when the relay server 100 is in normal operation, and from the management server 200 when the relay server 100 is not in normal operation.

### 2.2 Hardware Construction

Hereinbelow, the hardware constructions of the relay server 100, the management server 200, and the clients 300, 300-2, . . . 300-n are explained.

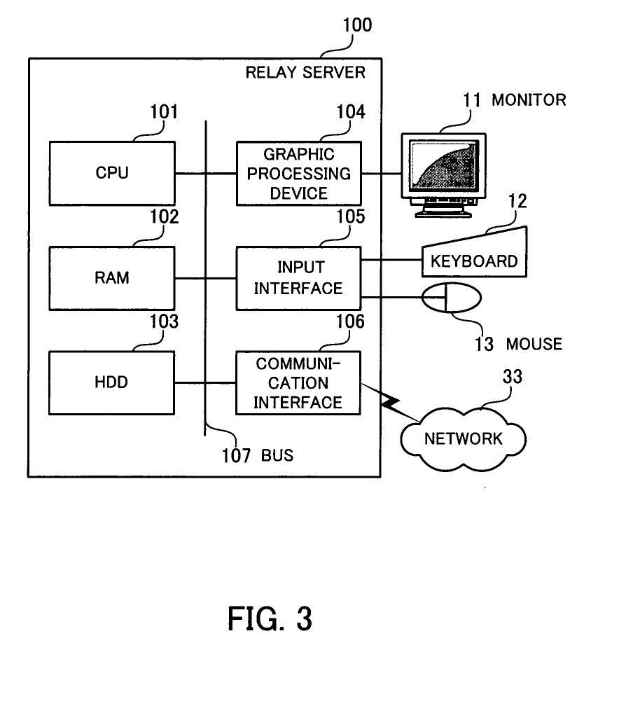

FIG. 3 is a diagram illustrating a hardware construction of a relay server used in the first embodiment. The entire relay server 100 is controlled by a CPU (central processing unit) 101, to which a RAM (random access memory) 102, an HDD (hard disk drive) 103, a graphic processing device 104, an input interface 105, and a communication interface 106 are connected through a bus 107. The RAM 102 temporarily stores at least portions of an OS (operating system) program and application programs which are executed by the CPU 101, as well as various types of data necessary for processing by the CPU 101. The HDD 103 stores the OS program and the application programs. A monitor 11 is connected to the graphic processing device 104, which makes the monitor 11 display an image on a screen in accordance with an instruction from the CPU 101. A keyboard 12 and a mouse 13 are connected to the input interface 105, which transmits signals sent from the keyboard 12 and the mouse 13, to the CPU 101 through the bus 107. The communication interface 106 is connected to the network 33, and exchanges data with other computers through the network 33.

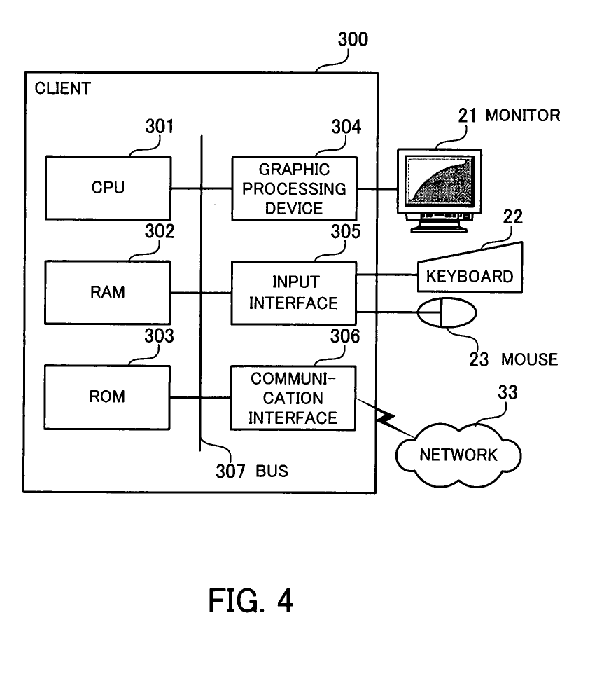

FIG. 4 is a diagram illustrating a hardware construction of the client 300 used in the first embodiment. The entire client 300 is controlled by a CPU (central processing unit) 301, to which a RAM (random access memory) 302, a ROM (read only memory) 303, a graphic processing device 304, an input interface 305, and a communication interface 306 are connected through a bus 307. The RAM 302 temporarily stores at least portions of an OS (operating system) program and application programs which are executed by the CPU 301, as well as various types of data necessary for processing by the CPU 301. The ROM 303 stores a basic program for initially accessing the relay server 100 when the client 300 is started up, i.e., powered on. A monitor 21 is connected to the graphic processing device 304, which makes the monitor 21 display an image on a screen in accordance with an instruction from the CPU 301. A keyboard 22 and a mouse 23 are connected to the input interface 305, which transmits signals sent from the keyboard 22 and the mouse 23, to the CPU 301 through the bus 307. The communication interface 306 is connected to the network 33.

Further, the management server 200 can also be realized by using a similar hardware construction to the relay server 100, and each of the other clients 300-2, . . . 300-n can also be realized by using a similar hardware construction to the client 300. Each of the clients 300, 300-2, . . . 300-n may further comprise a HDD (hard disk drive) and/or a nonvolatile semiconductor memory such as a flash memory.

By using the above hardware constructions, it is possible to realize the processing functions of the distributed file system according to the first embodiment.

### 2.3 Functions of Servers

Hereinbelow, the functions of the relay server 100 and the management server 200 are explained.

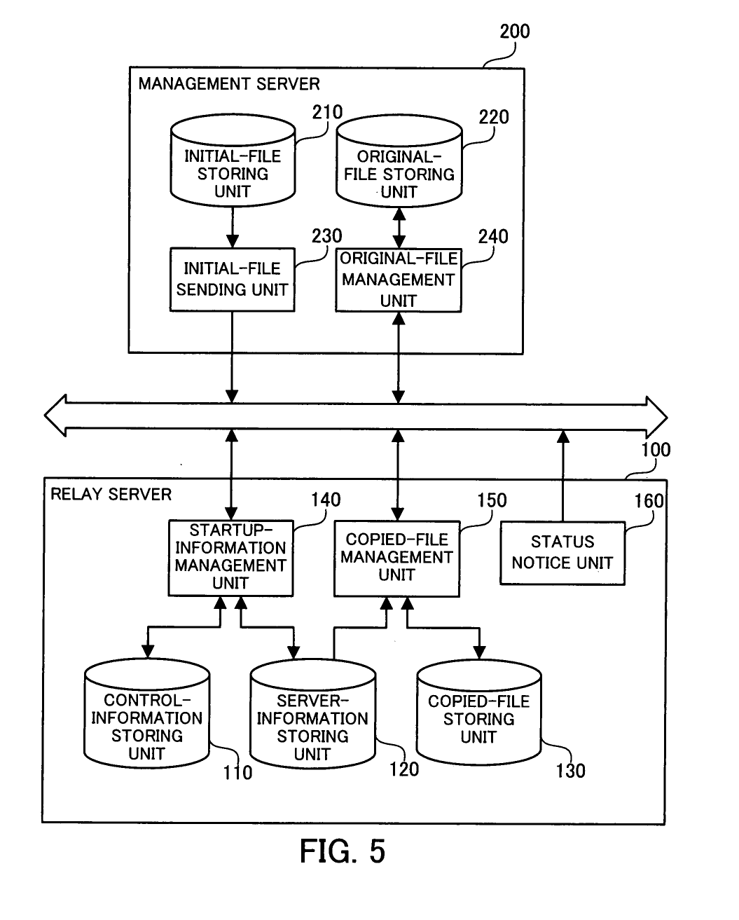

FIG. 5 is a block diagram illustrating the functions of the relay server 100 and the management server 200 according to the first embodiment. As illustrated in FIG. 5, the relay server 100 comprises a control-information storing unit 110, a server-information storing unit 120, a copied-file storing unit 130, a startup-information management unit 140, a copied-file management unit 150, and a status notice unit 160.

Each of the startup-information management unit 140 and the copied-file management unit 150 can communicate with the management server 200. In addition, each of the startup-information management unit 140, the copied-file management unit 150, and the status notice unit 160 can communicate with the clients 300, 300-2, . . . 300-n.

The control-information storing unit 110 stores information which is necessary when each of the clients 300, 300-2, . . . 300-n starts up. Specifically, the control-information storing unit 110 stores the OS program, a boot loader (which is a program for starting the OS), and a RAM disk driver (which is a program for using the RAM as a file storage device). In addition, the control-information storing unit 110 further stores an input/output driver, which is a program for receiving and outputting a file through a network. Specifically, the input/output driver controls the computer realizing each client so that when the client performs an operation on a file, the client checks the operational status of the relay server 100, performs an operation on the copy of the file stored in the relay server 100 when the relay server 100 is in normal operation, and performs an operation on the file stored in the management server 200 when the relay server 100 is not in normal operation.

The server-information storing unit 120 stores server information, which defines one or more communication procedures to be used when the clients 300, 300-2, . . . 300-n access the relay server 100 or the management server 200. The server information includes information on communication protocols to be used by the relay server 100 and the management server 200. The communication protocols to be used by the relay server 100 and the management server 200 may or may not be identical.

The copied-file storing unit 130 stores the copies of files stored in the management server 200. Specifically, the copied-file storing unit 130 stores files of application programs, setting files, and data files. The copied-file storing unit 130 manages the copies of files so as to maintain the directory structure (i.e., the hierarchic structure of files) of the management server 200.

The startup-information management unit 140 receives from the management server 200 an initial file, in which information to be sent to each of the clients 300, 300-2, . . . 300-n when the client starts up. As mentioned before, the initial file contains at least a part of information which is to be stored in the control-information storing unit 110 and the server-information storing unit 120. The startup-information management unit 140 updates the information stored in the control-information storing unit 110 and the server-information storing unit 120, in correspondence with the received initial file.

In addition, the startup-information management unit 140 receives a startup notice, which is sent from each of the clients 300, 300-2, . . . 300-n when the client starts up. Then, the startup-information management unit 140 sends to the client (i.e., the source of the startup notice) the information stored in the control-information storing unit 110 and the server-information storing unit 120 as startup information.

The copied-file management unit 150 receives a file-operation request, which can be sent from each of the clients 300, 300-2, . . . 300-n. The file-operation request is a file-acquisition request or a file-update request.

When the copied-file management unit 150 receives a file-acquisition request, the copied-file management unit 150 searches the files stored in the copied-file storing unit 130, for the file which is designated by the file-acquisition request to be operated. When the designated file is not stored in the copied-file storing unit 130, the copied-file management unit 150 acquires the file from the management server 200 in accordance with the server information stored in the server-information storing unit 120, and stores the acquired file in the copied-file storing unit 130. Thereafter, the copied-file management unit 150 sends the designated file to the client which has sent the file-update request.

When the copied-file management unit 150 receives a file-update request, the copied-file management unit 150 updates one of the files stored in the copied-file storing unit 130 which is designated by the file-update request to be operated, and sends a result of the update to the client which has sent the file-update request. In addition, the copied-file management unit 150 periodically checks the update status of the files stored in the copied-file storing unit 130. When an updated file is stored in the copied-file storing unit 130, the copied-file management unit 150 sends details of the update to the management server 200, so that the details of the update are reflected in the original of the file stored in the management server 200.

Each of the clients 300, 300-2, . . . 300-n periodically sends a state-check request to the status notice unit 160. When the status notice unit 160 receives the state-check request, the status notice unit 160 checks whether or not all the functions of the relay server 100 normally operate, and sends the result of the checking to the source of the state-check request. In addition, when the operational status of the relay server 100 is changed from “abnormal” to “normal,” the status notice unit 160 broadcasts through the network 33 a packet indicating the recovery of the relay server 100.

The management server 200 comprises an initial-file storing unit 210, an original-file storing unit 220, an initial-file sending unit 230, and an original-file management unit 240.

The initial-file storing unit 210 stores the initial file. As mentioned before, the initial file contains at least a part of information which is to be stored in the control-information storing unit 110 and the server-information storing unit 120. The initial file is produced in advance by an administrator, and can be updated by the administrator when necessary.

The original-file storing unit 220 stores the originals of the files of application programs, the setting files, and the data files which are used by the clients 300, 300-2, . . . 300-n.

When the administrator inputs a delivery command into the management server 200, the initial-file sending unit 230 sends to the relay server 100 the initial file stored in the initial-file storing unit 210.

The original-file management unit 240 receives a file-operation request, which is sent from one of the relay server 100 and the clients 300, 300-2, . . . 300-n. The file-operation request is a file-acquisition request or a file-update request. When the original-file management unit 240 receives a file-acquisition request, the original-file management unit 240 acquires from the original-file storing unit 220 the original of the file which is designated by the file-acquisition request to be operated, and sends the acquired file to the relay server 100 or one of the clients 300, 300-2, . . . 300-n which has sent the file-acquisition request. When the original-file management unit 240 receives a file-update request, the original-file management unit 240 updates one of the files stored in the original-file storing unit 220 which is designated by the file-update request to be operated, and sends information on completion of the update to the relay server 100 or one of the clients 300, 300-2, . . . 300-n which has sent the file-update request.

### 2.4 Functions of Clients

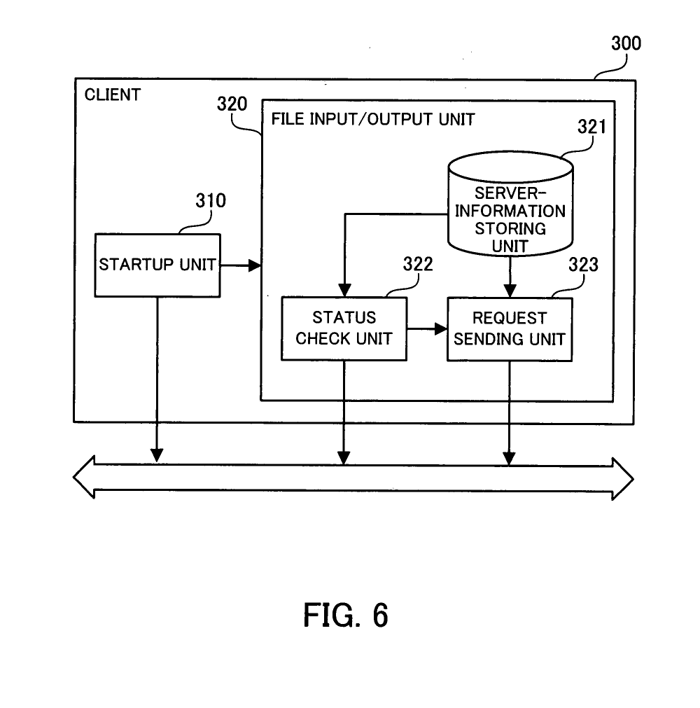

Hereinbelow, the functions of the clients 300, 300-2, . . . 300-n are explained. FIG. 6 is a block diagram illustrating the functions of the client 300 according to the first embodiment. The client 300 is realized by programs stored in the ROM 303, and comprises a startup unit 310 and a file input/output unit 320.

When a startup signal of the client 300 (i.e., a signal indicating that the client 300 is powered on) is activated, the startup unit 310 starts operation. Specifically, when the startup unit 310 detects the (activated) startup signal, the startup unit 310 broadcasts through the network 33 a packet containing a notice of the startup of the client 300, since the startup unit 310 does not have the address of the relay server 100 at the time of the startup of the client 300. The broadcasted packet reaches the relay server 100.

The relay server 100 sends the startup information to the client 300 in response to the startup notice. When the startup unit 310 receives the startup information, the startup unit 310 starts up the client 300 in accordance with the startup information. Specifically, the startup unit 310 loads in the RAM 302 the boot loader, the OS program, and the RAM disk driver which are contained in the received startup information. Then, the startup unit 310 starts the OS program by executing the boot loader. In addition, the startup unit 310 loads in the RAM 302 the input/output driver and the server information which are also contained in the received startup information. Details of the boot process through the network are defined by PXE (Preboot execution Environment).

The file input/output unit 320 receives and outputs files through the network 33. However, the concrete functions of the file input/output unit 320 are not defined before startup of the client 300, and are defined by the input/output driver and the server information, which are loaded in the RAM 302 by the startup unit 310.

After the startup processing is completed, a server-information storing unit 321, a status check unit 322, and a request sending unit 323 are realized in the file input/output unit 320.

The server-information storing unit 321 stores the server information acquired by the startup unit 310.

The status check unit 322 sends a state-check request to the relay server 100 in accordance with the server information stored in the server-information storing unit 321, and periodically sends the state-check request to the relay server 100 as long as the status check unit 322 receives from the relay server 100 a response indicating that the relay server 100 is in normal operation. When the status check unit 322 receives from the relay server 100 a response indicating that the relay server 100 is not normal, the status check unit 322 stops the transmission of the state-check request. When the status check unit 322 receives a notice of recovery of the relay server 100, the status check unit 322 restarts the transmission of the state-check request.

The request sending unit 323 receives a file input/output command from the OS program or one of the application programs. The file input/output command is issued when the OS program or one of the application programs needs a file which has not yet been acquired, or when a file loaded in the RAM 302 is updated.

When the request sending unit 323 receives the file input/output command, the request sending unit 323 inquires of the status check unit 322 the operational status of the relay server 100. When the relay server 100 is in normal operation, the request sending unit 323 sends to the relay server 100 a file-operation request corresponding to the file input/output command. When the relay server 100 is not in normal operation, the request sending unit 323 sends the file-operation request to the management server 200. At this time, the file-operation request is transmitted in accordance with one of the communication procedures indicated in the server information stored in the server-information storing unit 321.

Further, each of the clients 300-2, . . . 300-n has similar function modules to the function modules which the client 300 has.

### 2.5 Server-Information Table

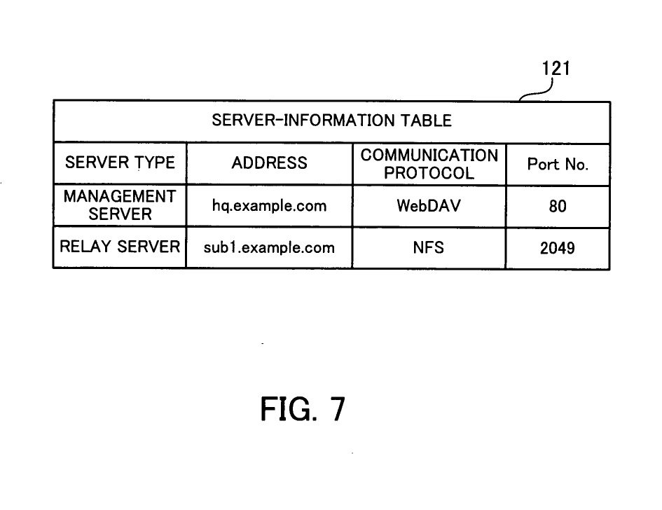

FIG. 7 is a diagram illustrating an example of a data structure of a server-information table according to the first embodiment. The server-information table 121 is stored in the server-information storing unit 120 in the relay server 100, and information items on each of the relay server 100 and information on the management server 200 are tabulated in association with each other in the server-information table 121.

The server-information table 121 indicated in FIG. 7 has the fields of “Server Type,” “Address,” “Communication Protocol,” and “Port Number.” The information items in the entries in each row in the server-information table 121 are associated with each other.

In the “Server Type” field, “Management Server” or “Relay Server” is set. In the “Address” field, the FQDN (Fully-Qualified Domain Name) of each server is set. The FQDN is constituted by a domain name and a server name, and uniquely identifies each server. In the “Communication Protocol” field, the name of a communication protocol to be used in the transmission of the file-operation request is set. In the “Port Number” field, the port number of a communication port which is provided in each server for receiving the file-operation request is set.

The startup-information management unit 140 registers information in the server-information table 121, or updates the information already registered in the server-information table 121, when necessary. In the example of FIG. 7, the server type “Management Server”, the address “hq.example.com”, the communication protocol “WebDAV”, and the port number “80” are registered for the management server 200.

### 2.6 Processing Sequences

Hereinbelow, sequences of processing which are performed in the distributed file system having the above constructions are explained. In the following explanations, it is assumed that the client 300 performs communication with the relay server 100 and the management server 200. Although not shown, the other clients can also perform similar operations.

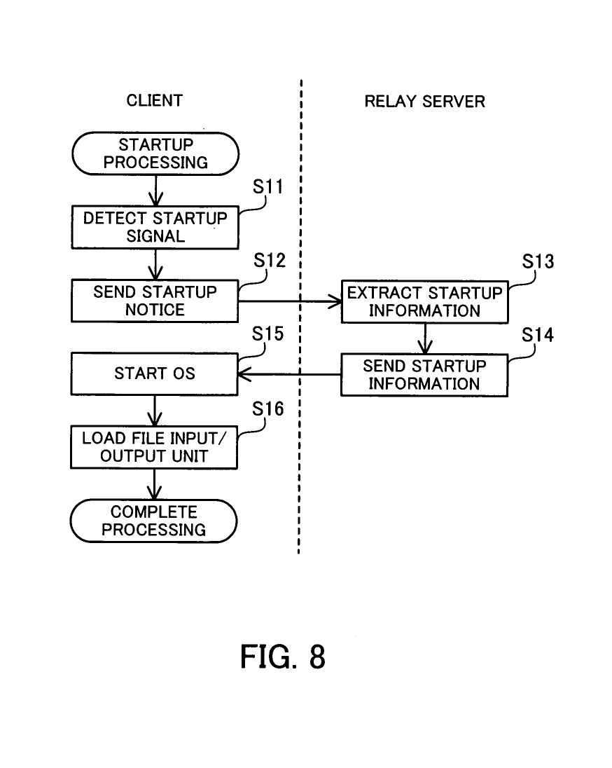

First, processing which is performed when the client 300 starts up is explained. FIG. 8 is a flow diagram indicating a sequence of startup processing according to the first embodiment. The processing indicated in FIG. 8 is explained below step by step.

<Step S11> The startup unit 310 detects a startup signal of the client 300 (i.e., a signal indicating that the client 300 is powered on).

<Step S12> The startup unit 310 broadcasts through the network 33 a packet containing a notice of the startup of the client 300.

<Step S13> The startup-information management unit 140 receives the broadcasted packet and acquires the notice of the startup of the client 300. Then, the startup-information management unit 140 extracts the boot loader, the OS program, the RAM disk driver, and the input/output driver from the control-information storing unit 110, and also extracts the server information from the server-information storing unit 120.

<Step S14> The startup-information management unit 140 sends to the startup unit 310 the information extracted in step S13 as startup information.

<Step S15> The startup unit 310 receives the startup information, loads the boot loader, the OS program, and the RAM disk driver in the RAM 302, and starts the OS by executing the boot loader.

<Step S16> The startup unit 310 loads the input/output driver and the server information in the RAM 302, and realizes the functions of the file input/output unit 320.

As indicated above, when the client 300 is powered on, the client 300 sends a notice of the startup of the client 300 to the relay server 100 in order to perform startup processing. In response to the notice of the startup, the relay server 100 sends to the client 300 startup information necessary for startup of the client 300.

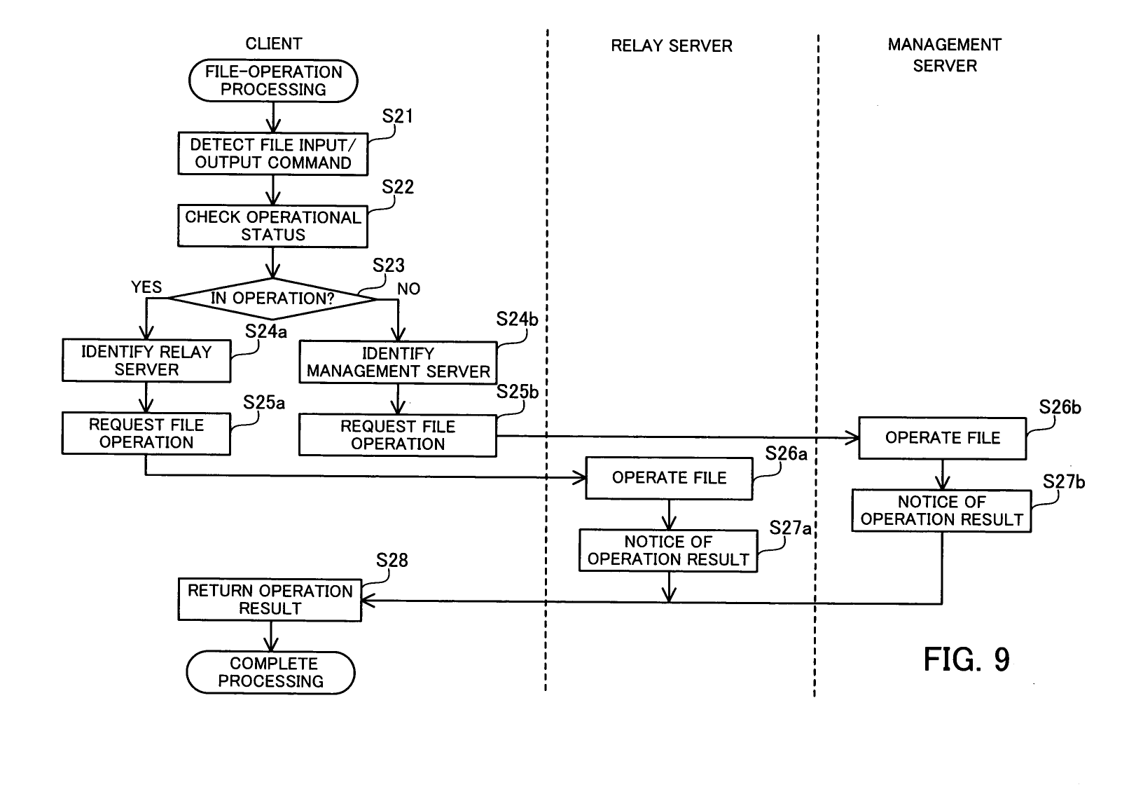

Next, processing which is performed when a file input/output command occurs in the client 300 is explained. FIG. 9 is a flow diagram indicating a sequence of file-operation processing according to the first embodiment. The processing indicated in FIG. 9 is explained below step by step.

<Step S21> The request sending unit 323 detects the file input/output command, which the OS program or an application program issues.

<Step S22> The request sending unit 323 inquires of the status check unit 322 and acquires information indicating the current operational status of the relay server 100.

<Step S23> The request sending unit 323 determines whether or not the relay server 100 is in normal operation, on the basis of the information acquired in step S22. When yes is determined in step S23, the operation goes to step S24a. When no is determined in step S23, the operation goes to step S24b.

<Step S24a> The request sending unit 323 acquires from the server-information storing unit 321 the server information on the relay server 100, so that the FQDN, the communication protocol, and the port number for accessing the relay server 100 are determined. Then, the request sending unit 323 determines the IP (Internet Protocol) address corresponding to the FQDN by using a DNS (Domain Name Server) server, which is not shown.

<Step S25a> The request sending unit 323 sends a file-operation request corresponding to the file input/output command to the copied-file management unit 150 on the basis of the IP address, the communication protocol, and the port number determined in step S24a.

<Step S26a> The copied-file management unit 150 receives the file-operation request, and executes the file operation corresponding to the file-operation request. Specifically, in the case where the file-operation request is a file-acquisition request, the copied-file management unit 150 acquires from the copied-file storing unit 130 or the original-file management unit 240 the file which is designated by the file-acquisition request to be operated. In the case where the file-operation request is a file-update request, the copied-file management unit 150 updates one of the files stored in the copied-file storing unit 130 which is designated by the file-update request to be operated.

<Step S27a> The copied-file management unit 150 notifies the request sending unit 323 of the result of the file operation executed in step S26a. Specifically, in the case where the file-operation request is a file-acquisition request, the copied-file management unit 150 notifies the request sending unit 323 of the acquired file or failure in the acquisition. In the case where the file-operation request is a file-update request, the copied-file management unit 150 notifies the request sending unit 323 of completion of or failure in the update.

<Step S24b> The request sending unit 323 acquires from the server-information storing unit 321 the server information on the management server 200, so that the FQDN, the communication protocol, and the port number for accessing the management server 200 are determined. Then, the request sending unit 323 determines the IP address corresponding to the FQDN by using a DNS server, which is not shown.

<Step S25b> The request sending unit 323 sends a file-operation request corresponding to the file input/output command to the original-file management unit 240 on the basis of the IP address, the communication protocol, and the port number determined in step S24b.

<Step S26b> The original-file management unit 240 receives the file-operation request, and executes the file operation corresponding to the file-operation request. Specifically, in the case where the file-operation request is a file-acquisition request, the original-file management unit 240 acquires from the original-file storing unit 220 the file which is designated by the file-acquisition request to be operated. In the case where the file-operation request is a file-update request, the original-file management unit 240 updates one of the files stored in the original-file storing unit 220 which is designated by the file-update request to be operated.

<Step S27b> The original-file management unit 240 notifies the request sending unit 323 of the result of the file operation executed in step S26b. Specifically, in the case where the file-operation request is a file-acquisition request, the original-file management unit 240 notifies the request sending unit 323 of the acquired file or failure in the acquisition. In the case where the file-operation request is a file-update request, the original-file management unit 240 notifies the request sending unit 323 of completion of or failure in the update.

<Step S28> The request sending unit 323 sends a response to the source of the file input/output command, where the response indicates the result of the file operation of which the request sending unit 323 is notified by the relay server 100 or the management server 200.

As indicated above, when the client 300 detects a file input/output command, the client 300 checks the operational status of the relay server 100. When the relay server 100 is in normal operation, the client 300 sends a file-operation request to the relay server 100. When the relay server 100 is not in normal operation, the client 300 sends a file-operation request to the management server 200. When one of the relay server 100 and the management server 200 receives the file-operation request, the one of the relay server 100 and the management server 200 acquires or updates a file, and sends a response to the client 300.

Although the management server 200 sends the initial file to the relay server 100 according to the first embodiment, alternatively, the relay server 100 can acquire the initial file by periodically accessing the management server 200.

In addition, the update of the copies of files stored in the relay server 100 are reflected in the original files stored in the management server 200 (i.e., write-back type processing is performed) according to the first embodiment, alternatively, it is possible to concurrently update a copy of a file and the original file, (i.e., to perform write-through processing).

In addition, in the distributed file system according to the first embodiment, each of the clients 300, 300-2, . . . 300-n periodically accesses the relay server 100 for checking the operational status of the relay server 100. Alternatively, the distributed file system may be arranged so that when an abnormality occurs in the relay server 100, one of the clients 300, 300-2, . . . 300-n which first detects the abnormality broadcasts a packet notifying the other clients of the occurrence of the abnormality. In this case, it is possible to suppress the operations of checking the operational status of the relay server 100 performed by the other clients. Further alternatively, the distributed file system may be arranged so that each client check the operational status of the relay server 100, and instead the relay server 100 broadcasts through the network 33 a packet indicating the operational status of the relay server 100.

In the distributed file system according to the first embodiment, each client can perform an operation on the copies of files through a local-area network when the copies of files can be normally used, and on the originals of the files through a wide-area network when the copies of files cannot be used. In particular, even when information on the communication procedures is not installed in each client in advance, each client can communicate through a local-area network and a wide-area network by using respectively different communication procedures. Therefore, even when the clients are thin clients, it is possible to maintain high response performance and availability.

### 3. Second Embodiment

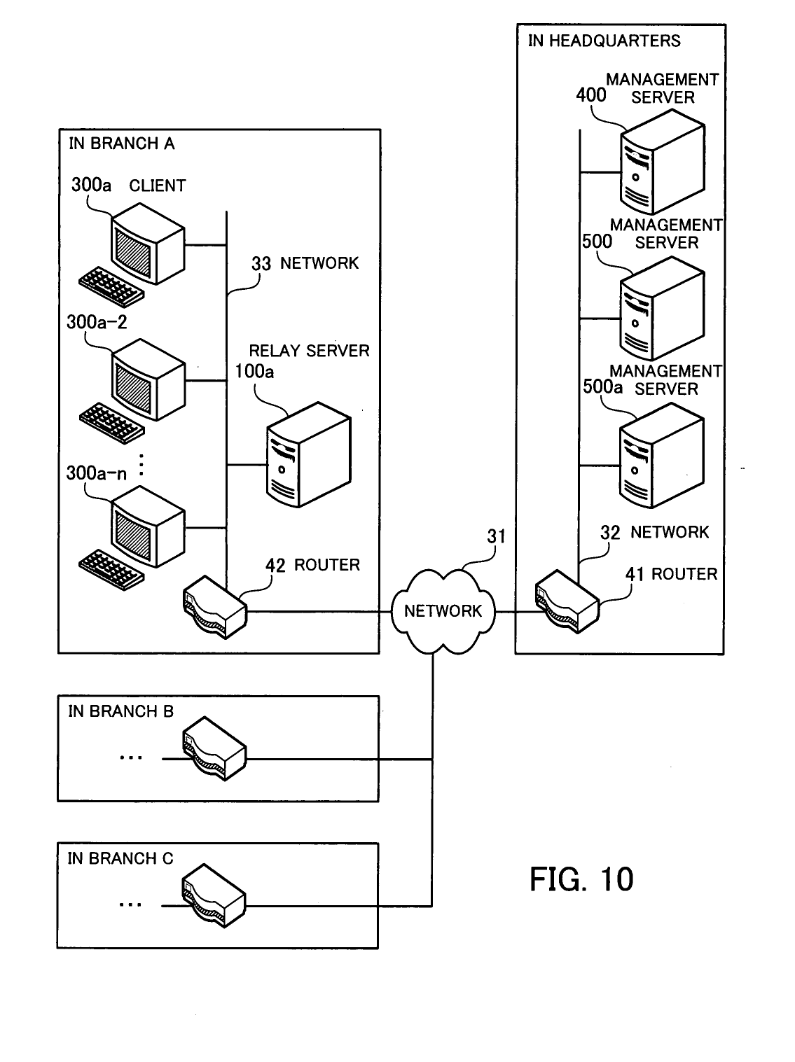

Hereinbelow, the second embodiment of the present invention is explained with reference to FIGS. 10 to 13. The following explanations are focused on the difference from the first embodiment, and the explanations on the same features as the first embodiment are not repeated unless necessary.

### 3.1 System and Hardware

FIG. 10 is a diagram illustrating an example of a configuration of a distributed file system according to the second embodiment. As the distributed file system according to the first embodiment, the distributed file system according to the second embodiment enables clients (located on the premises of branches of a company) to use files managed by a server located on the premises of the headquarters of the company. However, the distributed file system according to the second embodiment is different from the distributed file system according to the first embodiment in that a plurality of servers for a plurality of file types are provided on the premises of the headquarters of the company. The provision of the servers for the respective file types makes the file management more flexible.

As illustrated in FIG. 10, a network 32, a router 41, and management servers 400, 500, and 500a are arranged on the premises of the headquarters of the company. The management servers 400, 500, and 500a are connected with the network 32, which is a local-area network in the headquarters of the company.

In addition, a network 33, a router 42, a relay server 100a, and clients 300a, 300a-2, . . . 300a-n are arranged on the premises of the branch A. The relay server 100a and the clients 300a, 300a-2, . . . 300a-n are connected with the network 33, which is a local-area network in the branch A. Furthermore, a similar construction to the branch A is provided in each of the branches B and C.

The management servers 400, 500, and 500a are file servers storing the originals of the files which are to be used by the clients 300a, 300a-2, . . . 300a-n, where different types of files are assigned to the management servers 400, 500, and 500a, respectively. The relay server 100a is a cache server which collectively manages copies of files stored in the management servers 400, 500, and 500a. In the case where each of the clients 300a, 300a-2, . . . 300a-n needs a file, the client acquires a copy of the file from the relay server 100a when the relay server 100a is in normal operation, and the original of the file from one of the management servers 400, 500, and 500a storing the file when the relay server 100a is not in normal operation.

Further, each of the management servers 400, 500, and 500a can be realized by using a similar hardware construction to the relay server 100 according to the first embodiment, and each of the clients 300a, 300a-2, . . . 300a-n can be realized by using a similar hardware construction to the client 300 according to the first embodiment.

### 3.2 Functions

Hereinbelow, the functions of the relay server 100a, the management servers 400, 500, and 500a, and the clients 300a, 300a-2, . . . 300a-n are explained.

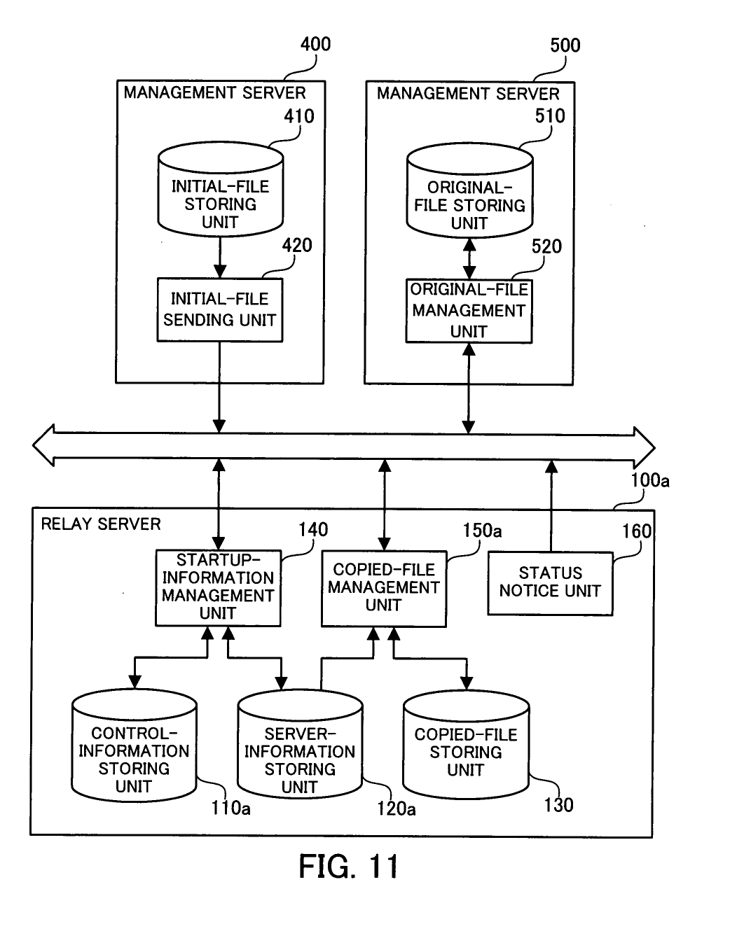

FIG. 11 is a block diagram illustrating the functions of the relay server 100a and part of the management servers 400, 500, and 500a according to the second embodiment. As illustrated in FIG. 11, the relay server 100a comprises a control-information storing unit 110a, a server-information storing unit 120a, a copied-file storing unit 130, a startup-information management unit 140, a copied-file management unit 150a, and a status notice unit 160. The copied-file storing unit 130, the startup-information management unit 140, and the status notice unit 160 in the distributed file system according to the second embodiment respectively have the same functions as the corresponding elements in the distributed file system according to the first embodiment.

The control-information storing unit 110a stores an OS program, a boot loader, a RAM disk driver, and an input/output driver. Specifically, the input/output driver controls the computer realizing each client so that when the client performs an operation on a file, the client checks the operational status of the relay server 100a, performs an operation on the copy of the file stored in the relay server 100 when the relay server 100 is in normal operation, and performs an operation on the file stored in one of the management servers 400, 500, and 500a storing the file when the relay server 100a is not in normal operation.

The server-information storing unit 120a stores server information, which defines one or more communication procedures to be used when the clients 300a, 300a-2, . . . 300a-n access the relay server 100a and the management servers 400, 500, and 500a. The server information according to the second embodiment further includes information on the type or types of the files which each of the management servers 400, 500, and 500a stores.

When the copied-file management unit 150a receives a file-operation request, which is sent from one of the clients 300a, 300a-2, . . . 300a-n, the copied-file management unit 150a performs an operation on a file stored in the copied-file storing unit 130 in accordance with the file-operation request. When the file which is designated by the file-update request to be operated is not stored in the copied-file storing unit 130, the copied-file management unit 150a acquires the designated file from one of the management servers 400, 500, and 500a storing the designated file, in accordance with the server information stored in the server-information storing unit 120a.

The management server 400 comprises an initial-file storing unit 410 and an initial-file sending unit 420. The initial-file storing unit 410 in the management server 400 has similar functions to the initial-file storing unit 210 in the management server 200 according to the first embodiment, and the initial-file sending unit 420 has similar functions to the initial-file sending unit 230 in the management server 200 according to the first embodiment.

The management server 500 comprises an original-file storing unit 510 and an original-file management unit 520. The original-file storing unit 510 has similar functions to the original-file storing unit 220 in the management server 200 according to the first embodiment, and the original-file management unit 520 has similar functions to the original-file management unit 240 in the management server 200 according to the first embodiment. However, the original-file storing unit 510 stores one or more types of files out of the files used by the clients 300a, 300a-2, . . . 300a-n.

Each of the clients 300a, 300a-2, . . . 300a-n has basically the same functions as the client 300 in the distributed file system according to the first embodiment (as illustrated in FIG. 6). However, the server information which each of the clients 300a, 300a-2, . . . 300a-n holds further includes the information indicating the one or more types of the files stored in each of the management servers. When the relay server 100a is not in normal operation, each of the clients 300a, 300a-2, . . . 300a-n sends the file-operation request to one of the management servers storing the file to be operated. In the following explanations on the second embodiment, it is assumed that the client 300a comprises a server-information storing unit 321a and a request sending unit 323a, instead of the server-information storing unit 321 and the request sending unit 323 according to the first embodiment.

### 3.3 Server-Information Table

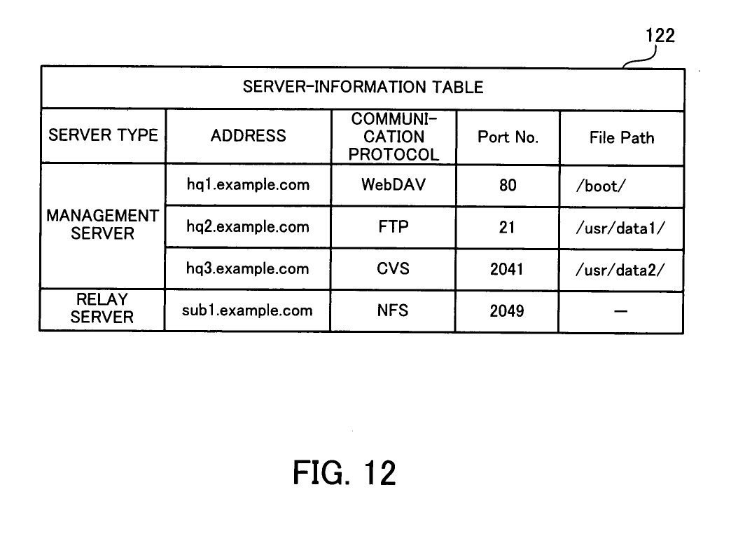

FIG. 12 is a diagram illustrating an example of a data structure of a server-information table according to the second embodiment. The server-information table 122 indicated in FIG. 12 is stored in the server-information storing unit 120a in the relay server 100a. In the server-information table 122, information items on each of the relay server 100a and the management servers 400, 500, and 500a are indicated in association with each other.

The server-information table 122 indicated in FIG. 12 has the fields of “Server Type,” “Address,” “Communication Protocol,” “Port Number,” and “File Path.” The information items in the entries in each row in the server-information table 121 are associated with each other. The fields of “Server Type,” “Address,” “Communication Protocol,” and “Port Number” in FIG. 12 are similar to the fields of “Server Type,” “Address,” “Communication Protocol,” and “Port Number” in the server-information table 121 of FIG. 7 according to the first embodiment.

In the “File Path” field, the name or names of one or more directories under which files are stored in each of the management servers are set. That is, the name or names of one or more directories in the “File Path” field indicates that the corresponding management server stores the files under the one or more directories. However, no directory name is set for the relay server 100a since the relay server 100a collectively stores the copies of the files stored in the management servers 400, 500, and 500a.

For example, the management server 400 stores files under the file path “/boot/”, where the directory name “boot” indicates the directory containing the initial file. In addition, the management server 500 stores files of application programs, setting files, and data files under the file path “/usr/data1/”, and the management server 500a stores files of application programs, setting files, and data files under the file path “/usr/data2/”.

### 3.4 Processing Sequence

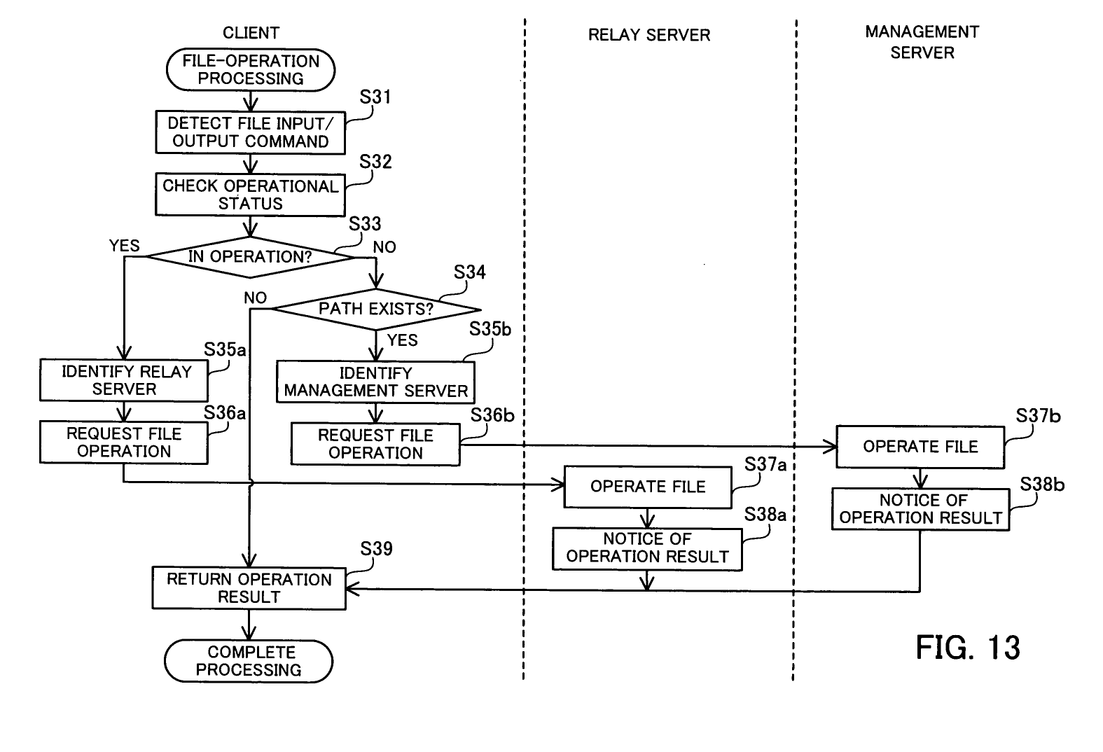

Next, processing which is performed when a file input/output command occurs in the client 300a is explained. FIG. 13 is a flow diagram indicating a sequence of file-operation processing according to the second embodiment. The processing indicated in FIG. 13 is explained below step by step.

<Step S31> The request sending unit 323a detects the file input/output command, which the OS program or an application program issues. At this time, the file input/output command contains the absolute path name of the file to be operated. The absolute path name is information which is constituted by a file name and one or more directory names and uniquely identifies the file.

<Step S32> The request sending unit 323a inquires of the status check unit 322, and acquires information indicating the current operational status of the relay server 100a.

<Step S33> The request sending unit 323a determines whether or not the relay server 100a is in normal operation, on the basis of the information acquired in step S32. When yes is determined in step S33, the operation goes to step S35a. When no is determined in step S33, the operation goes to step S34.

<Step S34> The request sending unit 323a refers to the server information stored in the server-information storing unit 321a, and determines whether or not a management server corresponding to the absolute path name designated by the file input/output command exists. When yes is determined in step S34, the operation goes to step S35b. When no is determined in step S34, the operation goes to step S39.

<Step S35a> The request sending unit 323a acquires from the server-information storing unit 321a server information on the relay server 100a, and determines the FQDN, the communication protocol, and the port number for accessing the relay server 100a. Then, the request sending unit 323a determines the IP address corresponding to the FQDN by using a DNS (Domain Name Server) server, which is not shown.

<Step S36a> The request sending unit 323a sends to the copied-file management unit 150a a file-operation request corresponding to the file input/output command on the basis of the IP address, the communication protocol, and the port number determined in step S35a.

<Step S37a> The copied-file management unit 150a receives the file-operation request, and executes the file operation corresponding to the file-operation request. Specifically, in the case where the file-operation request is a file-acquisition request, the copied-file management unit 150a acquires from one of the copied-file storing unit 130 and the management servers 500 and 500a the file which is designated by the file-acquisition request to be operated. In the case where the file-operation request is a file-update request, the copied-file management unit 150a updates one of the files stored in the copied-file storing unit 130 which is designated by the file-update request to be operated.

<Step S38a> The copied-file management unit 150a notifies the request sending unit 323a of the result of the file operation executed in step S37a.

<Step S35b> The request sending unit 323a acquires from the server-information storing unit 321a server information on a management server which stores the file to be operated, and determined the FQDN, the communication protocol, and the port number for accessing the management server. Then, the request sending unit 323a determines the IP address corresponding to the FQDN by using a DNS server, which is not shown.

<Step S36b> The request sending unit 323a sends a file-operation request corresponding to the file input/output command to one of the management servers 500 and 500a on the basis of the IP address, the communication protocol, and the port number determined in step S35b. In the following explanations, it is assumed that the request sending unit 323a sends the file-operation request to the management server 500.

<Step S37b> The original-file management unit 520 executes the file operation corresponding to the file-operation request, which the management server 500 receives. Specifically, in the case where the file-operation request is a file-acquisition request, the original-file management unit 520 acquires from the original-file storing unit 510 the file which is designated by the file-acquisition request to be operated. In the case where the file-operation request is a file-update request, the original-file management unit 520 updates one of the files stored in the original-file storing unit 510 which is designated by the file-update request to be operated.

<Step S38b> The original-file management unit 520 notifies the request sending unit 323a of the result of the file operation executed in step S37b.

<Step S39> The request sending unit 323a sends a response to the source of the file input/output command, where the response indicates the result of the processing corresponding to the file input/output command. Specifically, in the case where it is determined in step S34 that no management server corresponding to the absolute path name exists, the response indicates that the absolute path name is invalid. When the request sending unit 323a is notified of the result of the processing corresponding to the file input/output command by one of the relay server 100a and the management servers 500 and 500a, the response indicates the result of the processing of which the request sending unit 323a is notified.

As indicated above, when the client 300a detects a file input/output command, the client 300a checks the operational status of the relay server 100a. When the relay server 100a is in normal operation, the client 300a sends a file-operation request to the relay server 100a. When the relay server 100a is not in normal operation, the client 300a determines a management server storing the file to be operated, and sends a file-operation request to the determined management server. When one of the relay server 100a and the management servers 500 and 500a receives the file-operation request, the one of the relay server 100a and the management servers 500 and 500a acquires or updates the file to be operated, and sends a response to the client 300a.

The distributed file system according to the second embodiment has similar advantages to the distributed file system according to the first embodiment. Further, in the distributed file system according to the second embodiment, when the client cannot use a copy of a file to be operated, each client can directly send a file-operation request to a management server storing the original of the file. Therefore, even when the client is a thin client, it is possible to more flexibly manage the files.

### 4. Third Embodiment

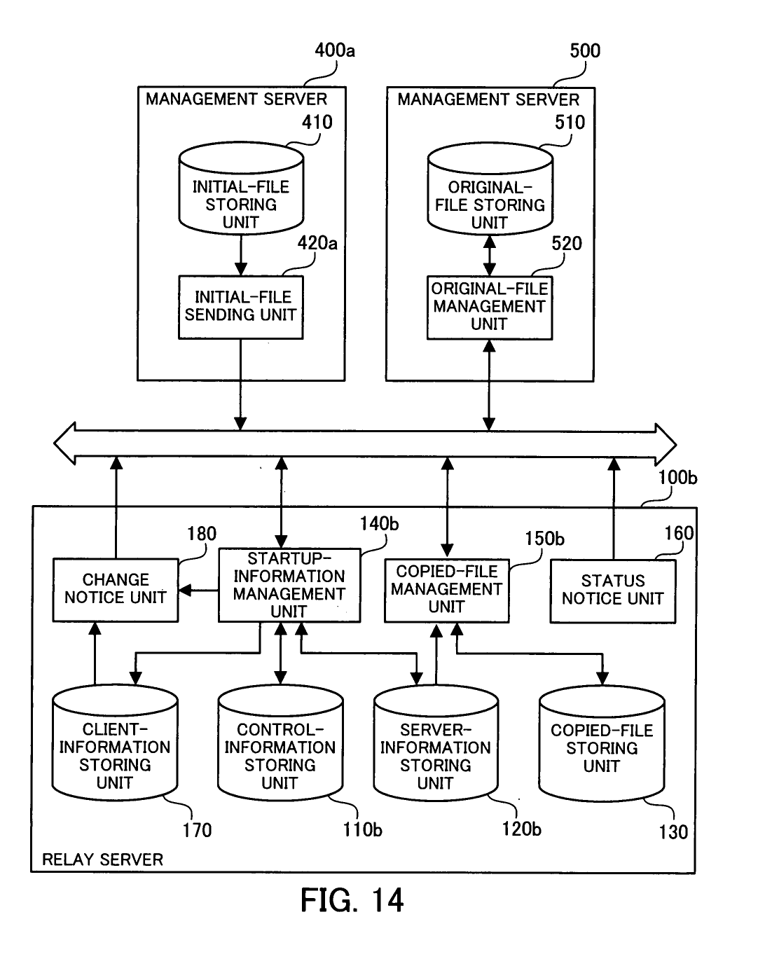

Hereinbelow, the third embodiment of the present invention is explained with reference to FIGS. 14 to 17. The following explanations are focused on the difference from the first and second embodiments, and the explanations on the same features as the first and second embodiments are not repeated unless necessary. In the distributed file system according to the third embodiment, a server arranged on the premises of the headquarters can be dynamically replaced.

The system configuration of the distributed file system according to the third embodiment is basically the same as the system configuration according to the second embodiment (illustrated in FIG. 10) except that the relay server 10b, instead of the relay server 100a according to the second embodiment, is connected to the network 33, the management server 400a, instead of the management server 400 according to the second embodiment, is connected to the network 32, and the clients 300b, 300b-2, . . . 300b-n, instead of the clients 300a, 300a-2, . . . 300a-n according to the second embodiment, are connected to the network 33.

Each of the relay server 100b and the management server 400a can be realized by a similar hardware construction to the relay server 100 according to the first embodiment, and each of the clients 300b, 300b-2, . . . 300b-n can be realized by a similar hardware construction to the client 300 according to the first embodiment.

### 4.1 Functions of Servers

Hereinbelow, the functions of the relay server 100b and the management servers 400a, 500, and 500a are explained.

FIG. 14 is a block diagram illustrating the functions of the relay server and part of the management servers according to the third embodiment. As illustrated in FIG. 14, the relay server 100b comprises a control-information storing unit 110b, a server-information storing unit 120b, a copied-file storing unit 130, a startup-information management unit 140b, a copied-file management unit 150b, a status notice unit 160, a client-information storing unit 170, and a change notice unit 180. The control-information storing unit 110b, the server-information storing unit 120b, the copied-file storing unit 130, the copied-file management unit 150b, and the status notice unit 160 in the distributed file system according to the third embodiment respectively have the same functions as the corresponding elements in the distributed file system according to the second embodiment.

The startup-information management unit 140b receives a startup notice, which is sent from each of the clients 300b, 300b-2, . . . 300b-n when the client starts up. On receipt of the startup notice, the startup-information management unit 140b sends the information stored in the control-information storing unit 110b and the server-information storing unit 120b as startup information to the client (the source of the startup notice). Thereafter, the startup-information management unit 140b registers in the client-information storing unit 170 information indicating that the client starts up. At this time, the client which starts up is identified by a MAC (Media Access Control) address which is contained in the startup notice. In the case where an IP address is dynamically assigned to the client (which starts up) by using the DHCP (Dynamic Host Configuration Protocol) function, the startup-information management unit 140b also registers the assigned IP address in the client-information storing unit 170.

In addition, the startup-information management unit 140b receives a notice of termination, which is sent from each of the clients 300b, 300b-2, . . . 300b-n when the client terminates operation. On receipt of the notice of termination, the startup-information management unit 140b registers in the client-information storing unit 170 information indicating that the client terminates operation.

Further, when the startup-information management unit 140b receives the initial file or a notice of an update from the management server 400a, the startup-information management unit 140b updates the information stored in the control-information storing unit 110b and the server-information storing unit 120b. When the startup-information management unit 140b detects a change in the server information, the startup-information management unit 140b sends the changed server information to the change notice unit 180.

The client-information storing unit 170 stores client information on the clients 300b, 300b-2, . . . 300b-n. The client information includes the address of each of the clients 300b, 300b-2, . . . 300b-n and information on the operational status of each of the clients 300b, 300b-2, . . . 300b-n.

When the change notice unit 180 receives the changed server information from the startup-information management unit 140b, the change notice unit 180 searches the client information stored in the client-information storing unit 170, and determines one or more clients which are in operation. Then, the change notice unit 180 sends the changed server information to the one or more clients.

The management server 400a comprises an initial-file storing unit 410 and an initial-file sending unit 420a. The initial-file storing unit 410 in the management server 400a has similar functions to the initial-file storing unit 210 in the management server 200 according to the first embodiment. When an administrator inputs a delivery command into the management server 400a, the initial-file sending unit 420a sends to the relay server 100b the initial file stored in the initial-file storing unit 410. In addition, when the administrator inputs into the management server 400a a command to redeliver the server information, the initial-file sending unit 420a extracts the server information from the initial-file storing unit 410, and sends the server information to the relay server 100b.

### 4.2 Functions of Clients

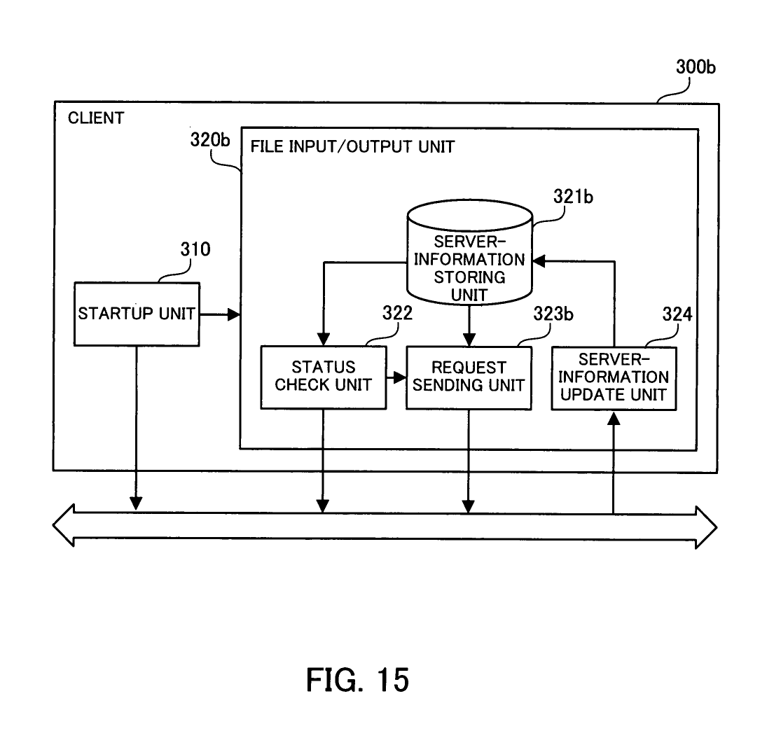

Hereinbelow, the functions of the clients 300b, 300b-2, . . . 300b-n are explained. FIG. 15 is a block diagram illustrating the functions of the client 300b according to the third embodiment. The client 300b comprises a startup unit 310 and a file input/output unit 320b. The startup unit 310 in the client 300b has similar functions to the startup unit 310 in the client 300 according to the first embodiment.

The file input/output unit 320b receives and outputs files through the network 33. However, the concrete functions of the file input/output unit 320b are defined by the input/output driver and the server information, which are loaded in the RAM 302 by the startup unit 310.

After the startup processing is completed, a server-information storing unit 321b, a status check unit 322, a request sending unit 323b, and a server-information update unit 324 are realized in the file input/output unit 320b. The server-information storing unit 321b in the client 300b has similar functions to the server-information storing unit 321a in the client 300a according to the second embodiment, and the status check unit 322 in the client 300b has similar functions to the status check unit 322 in the client 300 according to the first embodiment.

When the request sending unit 323b receives a file input/output command, the request sending unit 323b inquires of the status check unit 322 the operational status of the relay server 10b. When the relay server 100b is in normal operation, the request sending unit 323b sends to the relay server 100b a file-operation request corresponding to the file input/output command. When the relay server 100b is not in normal operation, the request sending unit 323b sends the file-operation request to the management server storing the file to be operated.

In addition, when the request sending unit 323b receives a prepare-to-terminate command from the OS program, the request sending unit 323b sends a notice of termination to the relay server 10b. The prepare-to-terminate command gives an order to terminate the OS and turn off the power.

When the server-information update unit 324 receives the changed server information from the relay server 10b, the server-information update unit 324 updates the server information stored in the server-information storing unit 321b with the received, changed server information.

Further, each of the clients 300b-2, . . . 300b-n has similar function modules to the function modules which the client 300b has.

### 4.3 Client-Information Table

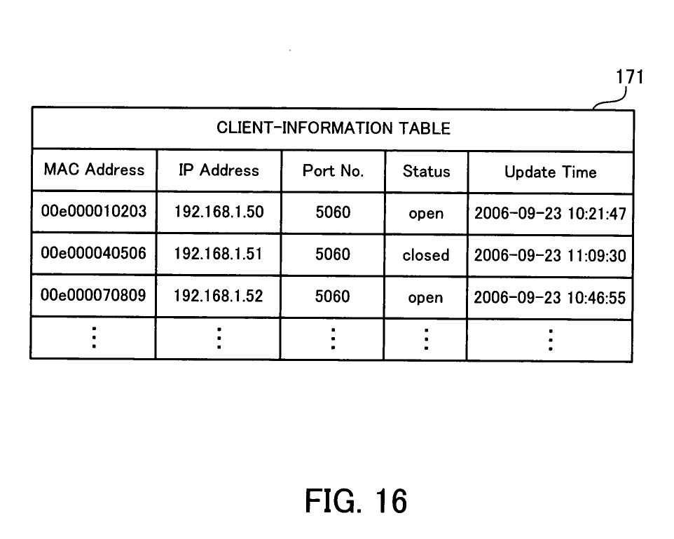

FIG. 16 is a diagram illustrating an example of a data structure of a client-information table according to the third embodiment. The client-information table 171 indicated in FIG. 16 is stored in the client-information storing unit 170 in the relay server 10b. In the client-information table 171, information items on each of the clients 300b, 300b-2, . . . 300b-n are indicated in association with each other.

The client-information table 171 indicated in FIG. 16 has the fields of “MAC Address,” “IP Address,” “Port Number,” “Status,” and “Update Time.” The information items in the entries in each row in the server-information table 121 are associated with each other.

In the “MAC Address” field, a MAC address which uniquely identifies each client is set. In the “IP Address” field, the IP address which is assigned to each client is set. In the “Port Number” field, the number of a communication port which is arranged in each client for receiving the changed server information is set. In the “Status” field, a value indicating the operational status of each client is set. Specifically, “open” is set when the client is in operation, and “closed” is set when the client is not in operation. In the “Update Time” field, the time at which the value in the “Status” field is updated is set.

Predetermined values are registered in advance in the information items in the client-information table 171 by the administrator. Thereafter, the startup-information management unit 140b updates the values of the information items in the client-information table 171 when necessary. For example, the MAC address “00e000010203”, the IP address “192.168.1.50”, the port number “5060”, the status “open”, and the update time “2006 Sep. 23 10:21:47” are registered for the client 300b.

### 4.4 Processing Sequence

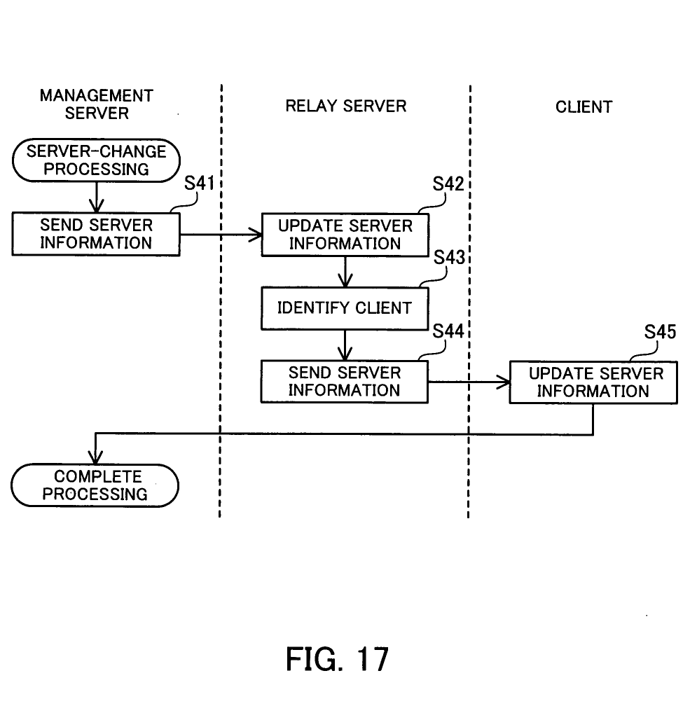

Next, processing which is performed when a file input/output command occurs in the client 300b is explained. FIG. 17 is a flow diagram indicating a sequence of server-change processing according to the third embodiment. The processing indicated in FIG. 17 is explained below step by step.

<Step S41> When the administrator inputs into the management server 400a a command to redeliver server information, the initial-file sending unit 420a extracts the server information from the initial-file storing unit 410. The server information contained in the initial file is updated in advance by the administrator. The initial-file sending unit 420a sends the changed server information to the startup-information management unit 140b.

<Step S42> The startup-information management unit 140b receives the changed server information, and updates the information stored in the server-information storing unit 120b, with the received, changed server information, and sends the changed server information to the change notice unit 180.

<Step S43> The change notice unit 180 acquires the changed server information, refers to the client information stored in the client-information storing unit 170, and determines the IP addresses and the port numbers of one or more clients which are in operation.

<Step S44> The change notice unit 180 sends the acquired, changed server information to the destinations identified by the IP addresses and the port numbers determined in step S43. In the following explanations, it is assumed that the changed server information is sent to the client 300b.

<Step S45> The server-information update unit 324 receives the changed server information, and updates the server information stored in the server-information storing unit 321b, with the received, changed server information.

As indicated above, the management server 400a sends the changed server information to the relay server 10b. Then, the relay server 100b checks the operational status of each of the clients 300b, 300b-2, . . . 300b-n, and sends the changed server information to one or more clients which are in operation. Each client which receives the changed server information updates the server information stored in the client, with the received, changed server information.

The distributed file system according to the third embodiment has similar advantages to the distributed file system according to the second embodiment. Further, in the distributed file system according to the third embodiment, it is possible to perform maintenance of the management servers 400a, 500, and 500a without affecting the clients 300b, 300b-2, . . . 300b-n. That is, the distributed file system according to the third embodiment has high availability.

### 5. Fourth Embodiment

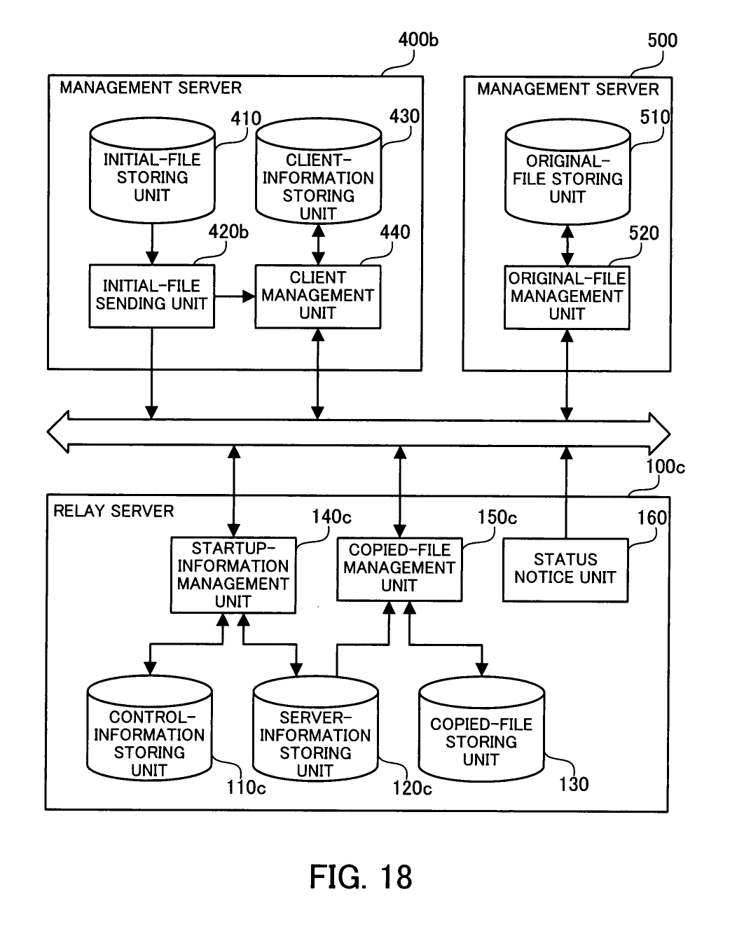

Hereinbelow, the fourth embodiment of the present invention is explained with reference to FIGS. 18 to 23. The following explanations are focused on the difference from the first, second, and third embodiments, and the explanations on the same features as the first, second, and third embodiments are not repeated unless necessary. In the distributed file system according to the fourth embodiment, a server arranged on the premises of the headquarters can be dynamically replaced irrespectively of the operational status of a relay server.

The system configuration of the distributed file system according to the fourth embodiment is basically the same as the system configuration of the second embodiment (illustrated in FIG. 10) except that the relay server 100c, instead of the relay server 100a, is connected to the network 33, the management server 400b, instead of the management server 400, is connected to the network 32, and the clients 300c, 300c-2, . . . 300c-n, instead of the clients 300a, 300a-2, . . . 300a-n, are connected to the network 33.

Each of the relay server 100c and the management server 400b can be realized by a similar hardware construction to the relay server 100 according to the first embodiment, and each of the clients 300c, 300c-2, . . . 300c-n can be realized by a similar hardware construction to the client 300 according to the first embodiment.

### 5.1 Functions of Servers

Hereinbelow, the functions of the relay server 100c and the management servers 400b, 500, and 500a are explained.

FIG. 18 is a block diagram illustrating the functions of the relay server and part of the management servers according to the fourth embodiment. As illustrated in FIG. 18, the relay server 100c comprises a control-information storing unit 110c, a server-information storing unit 120c, a copied-file storing unit 130, a startup-information management unit 140c, a copied-file management unit 150c, and a status notice unit 160. The control-information storing unit 110c, the server-information storing unit 120c, the copied-file storing unit 130, the copied-file management unit 150c, and the status notice unit 160 in the distributed file system according to the fourth embodiment respectively have the same functions as the corresponding elements in the distributed file system according to the second embodiment.

The startup-information management unit 140c receives a startup notice, which is sent from each of the clients 300c, 300c-2, . . . 300c-n when the client starts up. On receipt of the startup notice, the startup-information management unit 140c sends the information stored in the control-information storing unit 110c and the server-information storing unit 120c as startup information to the client (the source of the startup notice). In addition, when the startup-information management unit 140c receives the initial file or a notice of an update from the management server 400b, the startup-information management unit 140c updates the information stored in the control-information storing unit 110c and the server-information storing unit 120c.

The management server 400b comprises an initial-file storing unit 410, an initial-file sending unit 420b, a client-information storing unit 430, and a client management unit 440. The initial-file storing unit 410 in the management server 400b has similar functions to the initial-file storing unit 210 in the management server 200 according to the first embodiment. When an administrator inputs a delivery command into the management server 400b, the initial-file sending unit 420b sends to the relay server 100c the initial file stored in the initial-file storing unit 410. In addition, the initial-file sending unit 420b extracts server information from the initial-file storing unit 410 in response a re-delivery command of server information from the administrator. At this time, the initial-file sending unit 420b sends the server information to the client management unit 440.

The client-information storing unit 430 stores a client-information table 431, which is similar to the client-information table 171 according to the third embodiment.

The client management unit 440 receives a registration request, which is sent from each of the clients 300c, 300c-2, . . . 300c-n. The registration request contains the MAC address, the IP address, the port number, the status information, and the startup time, where the status information indicates whether or not each client is in operation. On receipt of the registration request, the client management unit 440 updates the client information stored in the client-information storing unit 430.

In addition, when the client management unit 440 receives the changed server information from the initial-file sending unit 420b, the client management unit 440 searches the client information stored in the client-information storing unit 430 for one or more clients which are in operation, and sends the changed server information to the one or more clients.

### 5.2 Functions of Clients

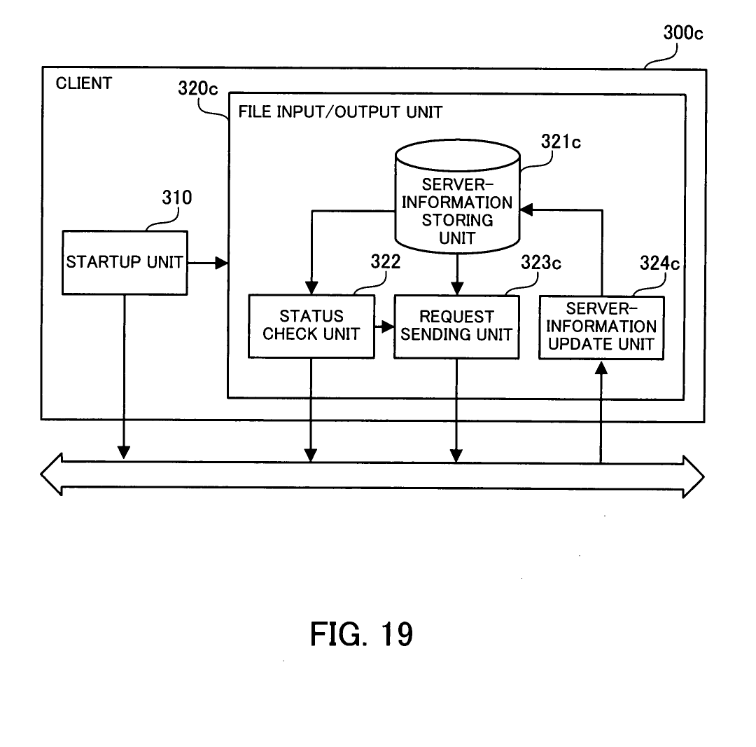

Hereinbelow, the functions of the clients 300c, 300c-2, . . . 300c-n are explained. FIG. 19 is a block diagram illustrating the functions of the client 300c according to the fourth embodiment. The client 300c comprises a startup unit 310 and a file input/output unit 320c. The startup unit 310 in the client 300c has similar functions to the startup unit 310 in the client 300 according to the first embodiment.

The file input/output unit 320c receives and outputs files through the network 33. However, the concrete functions of the file input/output unit 320c are defined by the input/output driver and the server information, which are loaded in the RAM 302 by the startup unit 310.

After the startup processing is completed, a server-information storing unit 321c, a status check unit 322, a request sending unit 323c, and a server-information update unit 324c are realized in the file input/output unit 320c. The server-information storing unit 321c in the client 300c has similar functions to the server-information storing unit 321a in the client 300a according to the second embodiment, and the status check unit 322 in the client 300c has similar functions to the status check unit 322 in the client 300 according to the first embodiment.

When the startup processing is completed, the request sending unit 323c acquires server information on the management server 400b from the server-information storing unit 321c, and sends a first registration request to the management server 400b, where the first registration request requests the management server 400b to register information indicating that the client starts up.

In addition, when the request sending unit 323c receives a prepare-to-terminate command from the OS program, the request sending unit 323c sends a second registration request to the management server 400b. The prepare-to-terminate command gives a client an order to terminate the OS and turn off the power, and the second registration request requests the management server 400b to register information indicating the termination of the client.

When the request sending unit 323c receives a file input/output command, the request sending unit 323c inquires of the status check unit 322 the operational status of the relay server 100c. When the relay server 100c is in normal operation, the request sending unit 323c sends to the relay server 100c a file-operation request corresponding to the file input/output command. When the relay server 100c is not in normal operation, the request sending unit 323c sends the file-operation request to the management server storing the file to be operated.

When the server-information update unit 324c receives the changed server information from the management server 400b, the server-information update unit 324c updates the server information stored in the server-information storing unit 321c with the received, changed server information.

Further, each of the clients 300c-2, . . . 300c-n has similar function modules to the function modules which the client 300c has.

### 5.3 Processing for Startup

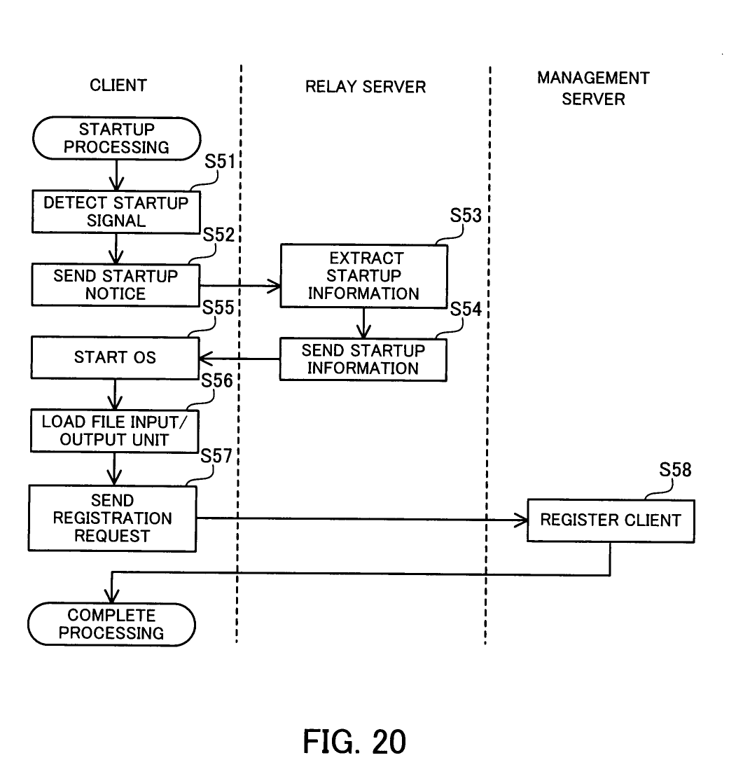

Next, processing which is performed when the client 300c starts up is explained. FIG. 20 is a flow diagram indicating a sequence of startup processing according to the fourth embodiment. The processing indicated in FIG. 20 is explained below step by step.

<Step S51> The startup unit 310 detects a startup signal of the client 300c (i.e., a signal indicating that the client 300c is powered on).

<Step S52> The startup unit 310 broadcasts through the network 33 a packet containing a notice of the startup of the client 300c.

<Step S53> The startup-information management unit 140c receives the broadcasted packet and acquires the notice of the startup of the client 300c. Then, the startup-information management unit 140c extracts the boot loader, the OS program, the RAM disk driver, and the input/output driver from the control-information storing unit 110c, and also extracts the server information from the server-information storing unit 120c.

<Step S54> The startup-information management unit 140c sends to the startup unit 310 the information extracted in step S53 as startup information.

<Step S55> The startup unit 310 receives the startup information, loads the boot loader, the OS program, and the RAM disk driver in the RAM 302, and starts the OS by executing the boot loader.

<Step S56> The startup unit 310 loads the input/output driver and the server information in the RAM 302, and realizes the functions of the file input/output unit 320.

<Step S57> The request sending unit 323c acquires from the server-information storing unit 321c the server information on the management server 400b, and determines the address of the management server 400b. Then, the request sending unit 323c sends to the management server 400b a registration request which requests to register information indicating that the client 300c starts up.

<Step S58> The client management unit 440 updates the client information stored in the client-information storing unit 430, in accordance with the received registration request.

As indicated above, when the client 300c is powered on, the client 300c sends a notice of the startup of the client 300c to the relay server 100c, and performs the startup processing. After the startup processing is completed, the client 300c sends a registration request to the management server 400b. Then, the management server 400b detects the startup of the client 300c, and holds the client information on the client 300c.

In the case where the IP address assigned to the client 300c is a private address which is effective only on the premises of the branch A, the NAPT (Network Address Port Translation) function of the router 42 converts the IP address and the port number contained in the registration request into a global IP address and a global port number, so that the management server 400b can access the client 300c.

### 5.4 Registration Request

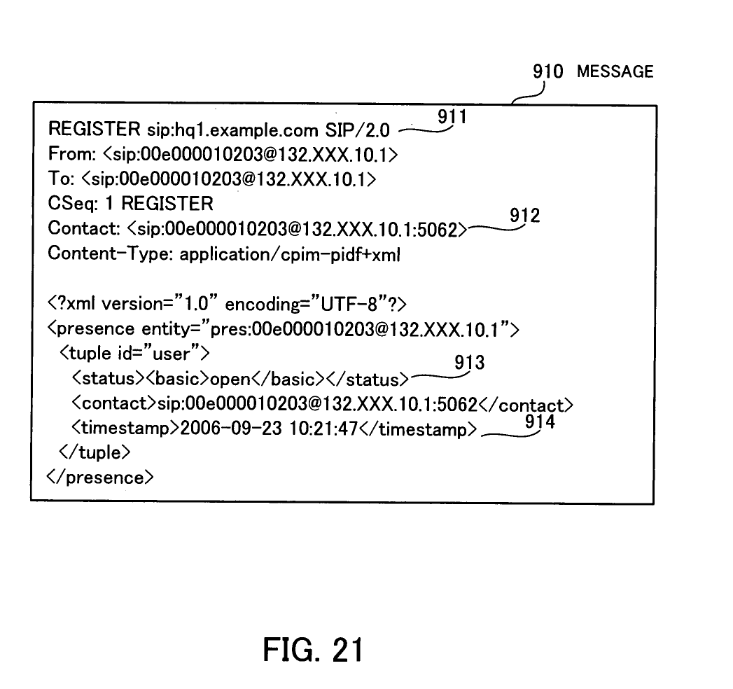

FIG. 21 is a diagram illustrating an example of a data structure of the registration request according to the fourth embodiment. FIG. 21 shows a message 910 of the registration request which the client 300c sends to the management server 400b after the startup processing is completed. In the message 910, SIP (Session Initiation Protocol) is used as a communication protocol in transmission and reception of the registration request.

In the message 910 of FIG. 21, the item 911 indicates that the message is a registration request addressed to the management server 400b, and the item 912 indicates the address which is to be used when the management server 400b sends the message to the client 300c. The address contains an IP address and a port number which are converted by the NAPT function and a MAC address. Specifically, in the item 912, the MAC address is “00e000010203”, the IP address is “132.XXX.10.1”, and the port number is “5062”. In addition, the item 913 indicates that the client 300c is in operation, and the item 914 indicates the time at which the client 300c starts up.

### 5.5 Processing When Server is Changed

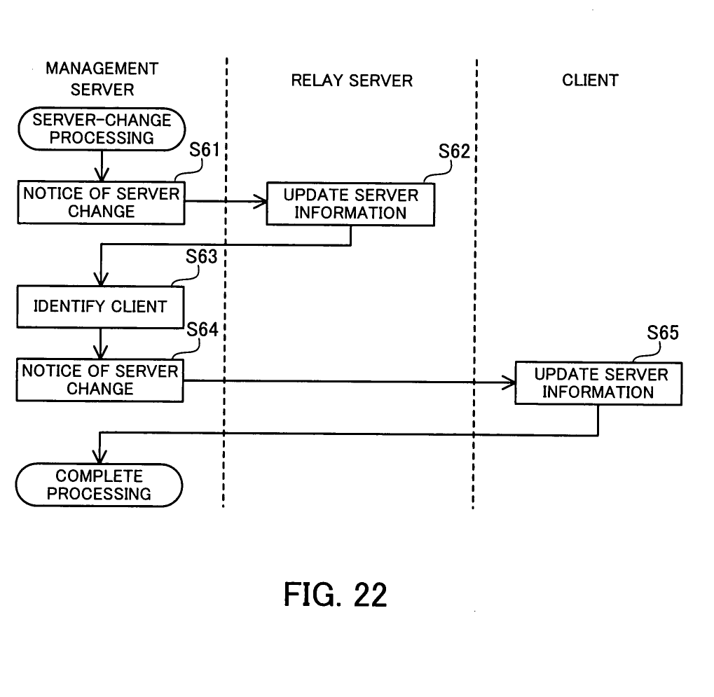

Next, processing which is performed when a server is changed is explained. FIG. 22 is a flow diagram indicating a sequence of server-change processing according to the fourth embodiment. The processing indicated in FIG. 22 is explained below step by step.

<Step S61> When the administrator inputs into the management server 400b a command to redeliver the server information, the initial-file sending unit 420b extracts the server information from the initial-file storing unit 410, and sends the changed server information to the startup-information management unit 140c.

<Step S62> The startup-information management unit 140c updates the information stored in the server-information storing unit 120c, with the received, changed server information.

<Step S63> The initial-file sending unit 420b sends the changed server information to the client management unit 440. Then, the client management unit 440 refers to the client information stored in the client-information storing unit 430, and determines the MAC addresses, the IP addresses, and the port numbers of one or more clients which are in operation.

<Step S64> The client management unit 440 sends the acquired, changed server information to the destinations identified by the MAC addresses, the IP addresses, and the port numbers determined in step S63. In the following explanations, it is assumed that the changed server information is sent to the client 300c.

<Step S65> The server-information update unit 324c updates the server information stored in the server-information storing unit 321c, with the received, changed server information.

As indicated above, the management server 400b sends the changed server information to the relay server 100c. Then, the relay server 100c updates the server information which the relay server 100c holds. In addition, the management server 400b also sends the changed server information to one or more clients which are in operation, so that each client which receives the changed server information updates the server information stored in the client, with the received, changed server information.

In the case where the global IP address and the global port number which are converted by the NAPT function of the router 42 are stored in the client-information storing unit 430, when the server information transmitted from the management server 400b is delivered to the router 42, the NAPT function in the router 42 inversely converts the global IP address and the global port number into a private IP address and a private port number, and the router 42 transfers the server information to the destination identified by the inversely converted (private) IP address and the inversely converted (private) port number.

### 5.6 Change Notice

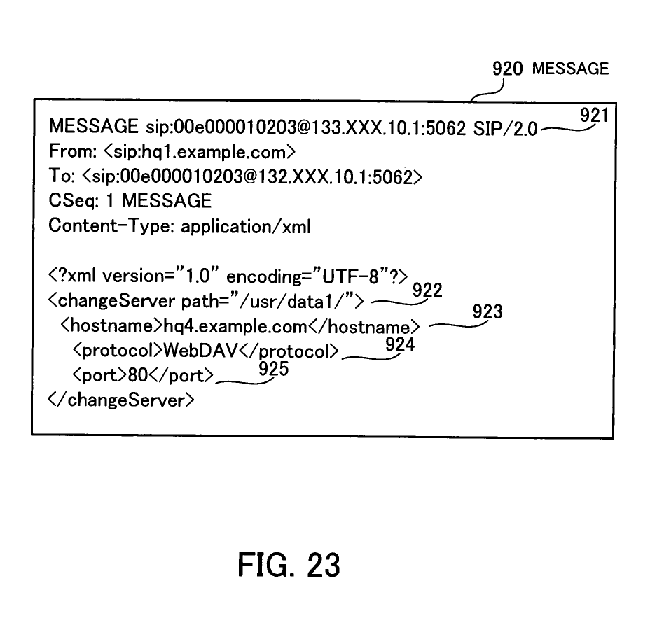

FIG. 23 is a diagram illustrating an example of a data structure of a change notice according to the fourth embodiment. FIG. 23 shows a message 920 of the change notice which the management server 400b sends to the client 300c when the management server 500 is replaced with another computer. In the message 920, SIP (Session Initiation Protocol) is used as a communication protocol in transmission and reception of the change notice.

In the message 920 of FIG. 23, the item 921 indicates that the message is addressed to the client 300c. Specifically, the item 921 is set so as to be directly transferred to the router 42. The item 922 indicates the file path to the files stored in the management server before being replaced, the item 923 indicates the FQDN of the management server after being replaced, the item 924 indicates the name of the communication protocol used by the management server after being replaced, and the item 925 indicates the port number of the communication port used by the management server after being replaced.

The distributed file system according to the fourth embodiment has similar advantages to the distributed file system according to the second embodiment. Further, in the distributed file system according to the fourth embodiment, it is possible to notify the clients 300b, 300b-2, . . . 300b-n of a change in the server information with high reliability even when the relay server 100c fails. Therefore, the distributed file system according to the fourth embodiment has high availability.

### 6. Fifth Embodiment

Hereinbelow, the fifth embodiment of the present invention is explained. The following explanations are focused on the difference from the first, second, third, and fourth embodiments, and the explanations on the same features as the first, second, third, and fourth embodiments are not repeated unless necessary. In the distributed file system according to the fifth embodiment, the features of the third and fourth embodiments are combined. That is, in the distributed file system according to the fifth embodiment, in the case where a server arranged on the premises of the headquarters is replaced, each client is notified of the change through the relay server when the relay server is in normal operation, and is directly notified of the change when the relay server is not in normal operation.

The system configuration of the distributed file system according to the fifth embodiment is basically the same as the system configuration of the second embodiment (illustrated in FIG. 10) except that the relay server 100b according to the third embodiment (as illustrated in FIG. 14), instead of the relay server 100a according to the second embodiment, is connected to the network 33, the clients 300c, 300c-2, . . . 300c-n according to the fourth embodiment (as illustrated in FIG. 19), instead of the clients 300a, 300a-2, . . . 300a-n, are connected to the network 33, and a management server 400c, instead of the management server 400, is connected to the network 32.

The management server 400c can be realized by using a similar hardware construction to the relay server 100 according to the first embodiment. In addition, the management server 400c has basically the same function modules as the management server 400b according to the fourth embodiment (as illustrated in FIG. 18) except that the management server 400c makes an attempt to send server information to the relay server 100b when the administrator inputs into the management server 400c a command to redeliver the server information, and directly sends the server information to the clients 300c, 300c-2, . . . 300c-n only when the relay server 100b is not in normal operation.

In addition, the management server 400c comprises an initial-file sending unit 420c according to the fifth embodiment, instead of the initial-file sending unit 420b according to the fourth embodiment.

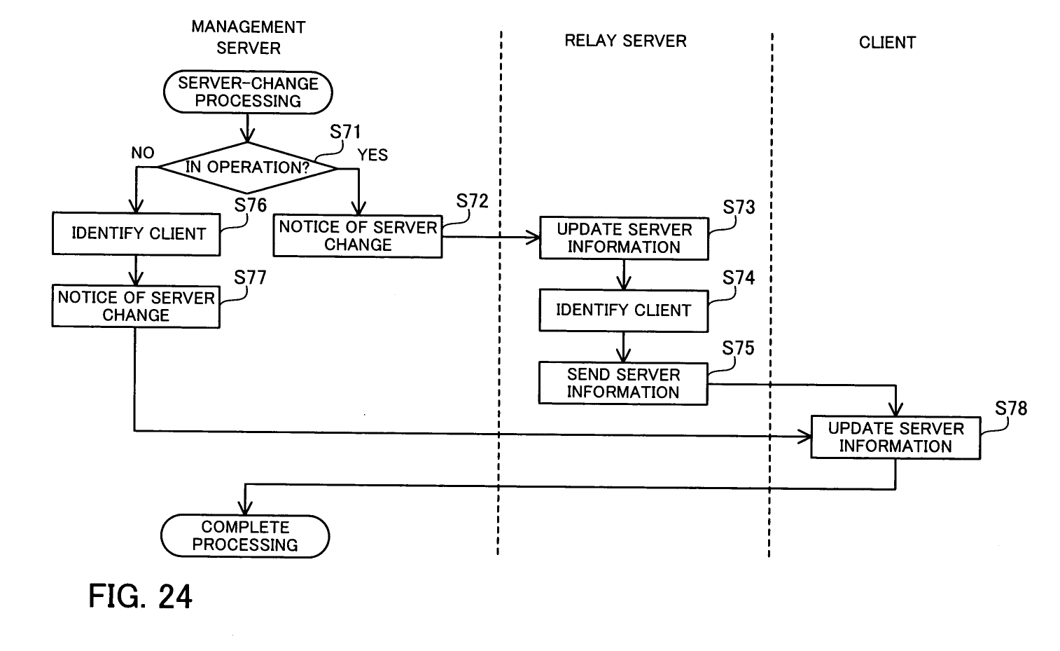

Next, processing which is performed when a server is changed is explained. FIG. 24 is a flow diagram indicating a sequence of server-change processing according to the fifth embodiment. The processing indicated in FIG. 24 is explained below step by step.

<Step S71> When the administrator inputs into the management server 400c a command to redeliver the server information, the initial-file sending unit 420c makes an attempt to access the relay server 10b, and determines whether or not the relay server 100b is in normal operation. When yes is determined in step S71, the operation goes to step S72. When no is determined in step S71, the operation goes to step S76.

<Step S72> The initial-file sending unit 420c extracts the changed server information from the initial-file storing unit 410, and sends the changed server information to the startup-information management unit 140b.

<Step S73> The startup-information management unit 140b updates the information stored in the server-information storing unit 120b, with the received, changed server information, and sends the changed server information to the change notice unit 180.

<Step S74> The change notice unit 180 acquires the changed server information, refers to the client information stored in the client-information storing unit 170, and determines the IP addresses and the port numbers of one or more clients which are in normal operation.

<Step S75> The change notice unit 180 sends the acquired, changed server information to the destinations identified by the IP addresses and the port numbers determined in step S74.

<Step S76> The initial-file sending unit 420c sends the changed server information to the client management unit 440. Then, the client management unit 440 refers to the client information stored in the client-information storing unit 430, and determines the MAC addresses, the IP addresses, and the port numbers of the one or more clients which are in normal operation.

<Step S77> The client management unit 440 sends the acquired, changed server information to the destinations identified by the MAC addresses, the IP addresses, and the port numbers determined in step S76. In the following explanations, it is assumed that the changed server information is sent to the client 300c.

<Step S78> The server-information update unit 324c updates the server information stored in the server-information storing unit 321c, with the received, changed server information.

As indicated above, the management server 400c sends the changed server information to the relay server 100c when the relay server 100c is in normal operation. Then, the relay server 100c updates the server information which the relay server 100c holds. In addition, the relay server 100c sends the changed server information to one or more clients which are in normal operation. On the other hand, when the relay server 100b is not in normal operation, the management server 400c directly sends the changed server information to the one or more clients which are in normal operation, and the one or more clients receive the changed server information, and update the server information which the one or more clients hold.

The distributed file system according to the fifth embodiment has similar advantages to the distributed file system according to the second embodiment. Further, in the distributed file system according to the fifth embodiment, it is possible to perform maintenance of the management servers 400c, 500, and 500a without service interruption.

In particular, it is possible to send to the clients 300c, 300c-2, . . . 300c-n a change notice notifying of a change in the server information with high reliability irrespectively of the operational status of the relay server 10b. In addition, when the relay server 100b is in normal operation, the traffic on the network 31 can be suppressed. Therefore, the distributed file system according to the fifth embodiment has high flexibility and high response performance.

### 7. Recording Medium Storing Program

The processing functions of the relay server according to each of the first to fifth embodiments which are explained above can be realized by a computer. In this case, a program describing details of processing for realizing the functions which each relay server should have is provided. When the computer executes the program, the processing functions of the relay server can be realized on the computer.

The program describing the details of the processing can be stored in a recording medium which can be read by the computer. The recording medium may be a magnetic recording device, an optical disk, an optical magnetic recording medium, a semiconductor memory, or the like. The magnetic recording device may be a hard disk drive (HDD), a flexible disk (FD), a magnetic tape (MT), or the like. The optical disk may be a DVD (Digital Versatile Disk), a DVD-RAM (Random Access Memory), a CD-ROM (Compact Disk Read Only Memory), a CD-R (Recordable)/RW (ReWritable), or the like. The optical magnetic recording medium may be an MO (Magneto-Optical Disk) or the like.

In order to put the program into the market, for example, it is possible to sell a portable recording medium such as a DVD or a CD-ROM in which the program is recorded. Alternatively, it is possible to store the program in a storage device belonging to a server computer, and transfer the program to another computer through a network.

The computer which executes the program stores the program in a storage device belonging to the computer, where the program is originally recorded in, for example, a portable recording medium, or is initially transferred from the server computer. The computer reads the program from the storage device, and performs processing in accordance with the program. Alternatively, the computer may directly read the program from the portable recording medium for performing processing in accordance with the program. Further alternatively, the computer can sequentially execute processing in accordance with each portion of the program every time the portion of the program is transferred from the server computer.

### 8. Advantages

As explained above, according to the present invention, server information and control information are sent to each client on startup of the client, where the server information defines a communication procedure to be used in communication with a file server, and the control information controls the client so as to send a file-acquisition request to a cache server when the cache server is in normal operation, and to the file server when the cache server is not in normal operation. Therefore, each client can be connected to the cache server when the cache server is in normal operation, and to the file server in accordance with the communication procedure (which is needed by the file server) when the cache server is not in normal operation. Consequently, the distributed file system according to the present invention has high availability and can be easily constructed at low cost by using a wide-area network.

### 9. Additional Matter

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

In particular, it is possible to realize a distributed file system by using an arbitrary combination of two or more of the features (constructions) of the first to fifth embodiments of the present invention explained before.

What is claimed is:

1. A computer-readable medium storing a file delivery program which makes a computer realize an apparatus for storing and delivering copies of files, said apparatus comprising:
a file storing unit which stores said copies of the files, where originals of the files are stored in one or more file servers connected to said computer through a network;
a server-information storing unit which stores server information defining one or more communication procedures in accordance with which communication with said one or more file servers is to be performed through said network;
a control-information storing unit which stores control information for controlling a client so that in a case of necessity of a file, the client sends a file-acquisition request to said computer when the computer is in operation, and to said one or more file servers in accordance with said server information when the computer is not in operation;
a startup-information sending unit which sends to said client said control information stored in said control-information storing unit and said server information stored in said server-information storing unit, in response to a startup notice, which is sent from the client when the client starts up; and
a file sending unit which sends, in response to a file-acquisition request received from said client, one of said copies of the files stored in said file storing unit corresponding to the file-acquisition request, to said client.

2. The computer-readable medium according to claim 1, wherein when no copy of said file corresponding to said file-acquisition request is stored in said file storing unit, said file sending unit acquires an original of the file from the one or more file servers by using said server information, and stores the original of the file in the file storing unit.

3. The computer-readable medium according to claim 1, wherein said apparatus further comprises a status notice unit which continually notifies said client of an operational status of said computer.

4. The computer-readable medium according to claim 1, wherein:
said server information further includes information indicating correspondences between each of the plurality of file servers and files stored in said each of the plurality of file servers; and
said control information controls said client so that said file-acquisition request which the client sends is addressed to one of said one or more file servers corresponding to said file when the computer is not in operation.

5. The computer-readable medium according to claim 1, wherein said apparatus further comprises a server-information update unit which updates said server information stored in said server-information storing unit when a change in said one or more file servers is detected, and sends the updated server information to said client.

6. A file delivery apparatus for storing and delivering copies of files, comprising:
a file storing unit which stores said copies of the files, where originals of the files are stored in one or more file servers connected to said file delivery apparatus through a network;
a server-information storing unit which stores server information defining one or more communication procedures in accordance with which communication with said one or more file servers is to be performed through said network;
a control-information storing unit which stores control information for controlling a client so that in a case of necessity of a file, the client sends a file-acquisition request to said file delivery apparatus when the file delivery apparatus is in operation, and to said one or more file servers in accordance with said server information when the file delivery apparatus is not in operation;
a startup-information sending unit which sends to said client said control information stored in said control-information storing unit and said server information stored in said server-information storing unit, in response to a startup notice, which is sent from the client when the client starts up; and
a file sending unit which sends, in response to a file-acquisition request received from said client, one of said copies of the files stored in said file storing unit corresponding to the file-acquisition request, to the client.

7. A distributed file system in which copies of files are stored and delivered, comprising:
a file server which includes,
a first file storing unit which stores said files, and
a first file sending unit which sends, in response to a file-acquisition request received through a network, one of said files stored in said first file storing unit corresponding to the file-acquisition request, to a device sending the file-acquisition request;
a cache server which includes,
a second file storing unit which stores said copies of the files,
a second file sending unit which sends, in response to a file-acquisition request received, one of said copies of the files stored in said second file storing unit corresponding to the file-acquisition request, to a device sending the file-acquisition request,
a server-information storing unit which stores server information defining a communication procedure in accordance with which communication with said file server is to be performed through said network,
a control-information storing unit which stores control information for controlling a computer so that in a case of necessity of a file, the computer acquires a copy of the file from said second file sending unit when the second file sending unit is in operation, and acquires the file from said file server in accordance with said server information when the second file sending unit is not in operation, and
a startup-information sending unit which sends, in response to a startup notice received, said control information stored in said control-information storing unit and said server information stored in said server-information storing unit, to a device sending the startup notice; and
a client which includes,
a startup unit which sends a startup notice to said cache server, and acquires said control information and said server information, when the client starts up, and
a file acquisition unit which, when the client needs a file, checks an operational status of said cache server, and acquires the needed file by sending a file-acquisition request to said cache server or said file server on the basis of said control information and said server information acquired by said startup unit.
